(19) United States
(12) Patent Application Publication
(10) Pub. No.: US 2026/0099783 A1
(43) Pub. Date: Apr. 9, 2026

(54) SYSTEMS AND METHODS FOR CONFIGURING MACHINE VISION TUNNELS

(71) Applicant: Cognex Corporation, Natick, MA (US)

(72) Inventors: Saul SANZ RODRIGUEZ, Aachen (DE); Jens RUETTEN, Aachen (DE); Tony DEPRE, Kohlscheid (DE); Bart STROO, Medway, MA (US)

(21) Appl. No.: 19/114,059

(22) PCT Filed: Sep. 22, 2023
(86) PCT No.: PCT/US2023/074949

§ 371 Date: Mar. 21, 2025

Related U.S. Application Data
(60) Provisional application No. 63/408,936, filed on Sep. 22, 2022.

(51) Int. Cl. G06Q 10/0631; G06Q 10/0875

(52) U.S. Cl. CPC G06Q 10/06313; G06Q 10/0875

(57) ABSTRACT

Systems and methods are provided for generating machine vision tunnel configurations. The systems and methods described herein may automatically generate a configuration summary of tunnel configurations for a prospective machine vision tunnel based on received parameters. The configuration summary may be modified via operator interaction with the configuration summary. The systems and methods described herein may also automatically generate and transmit a bill of materials report, a tunnel commissioning report, or a graphical representation of an approved tunnel configuration, including generating some or all of these data sets dynamically in response to operator inputs.

### CROSS-REFERENCE TO RELATED APPLICATIONS

This application claims priority to U.S. Provisional Application No. 63/408,936, filed Sep. 22, 2022, the entire contents of which is incorporated herein by reference.

### STATEMENT REGARDING FEDERALLY SPONSORED RESEARCH

N/A

### BACKGROUND

The present technology relates to imaging systems, including machine vision tunnels that are configured to acquire and analyze images, such as, e.g., multi-dimensional images of objects or symbols (e.g., barcodes).

Machine vision tunnels are generally configured for use in capturing images of objects or symbols and analyzing the images to identify the objects, detect defects, decode the symbols, etc. Accordingly, machine vision tunnels generally include one or more devices for image acquisition and image processing. These devices may be used to acquire images of objects within a predetermined area, and can sometimes also analyze acquired images. For example, machine vision devices in a tunnel can acquire images of objects passing through the tunnel and one or more of the devices can analyze the acquired images to decode symbols therein (e.g., barcodes or text), detect object defects, or perform other vision tasks. In some tunnel contexts, imaging devices for a tunnel can be arranged to acquire images of objects that may be larger than a corresponding field of view (“FOV”) for the imaging devices or to acquire images of objects that may be moving relative to the imaging devices.

The discussion above is merely provided for general background information and is not intended to be used as an aid in determining the scope of the claimed subject matter.

### SUMMARY

Examples of the technology disclosed herein provide methods and systems for configuring machine vision tunnels. In some examples described herein, a machine vision tunnel can be configured based on particular data associated with the tunnel, including to quickly and adaptably configure a prospective tunnel for a particular operational site and imaging application. For example, a configurator module of an electronic processing device can selectively access particular application data, equipment data, site data, etc. from dispersed and potentially extensive data sources and utilize that data to efficiently identify optimal or customizable configurations for a tunnel. Thus, for example, configuration details for particular tunnels can be quickly and customizably determined through selective use of data regarding available equipment as well as requirements and constraints for a particular site or application. These configuration details can then support improved efficiency and other benefits with regard to manufacture or other assembly of necessary equipment for a tunnel, installation or initialization of machine vision systems for a tunnel, or maintenance or upgrade operations for existing tunnels.

In this regard, some examples may determine one or more tunnel configurations for a prospective tunnel based on received data. Generally, a tunnel configuration is a set of tunnel parameters that can specify the components and structural or electronic (e.g., software) arrangement thereof for a particular tunnel. Thus, via specified tunnel parameters, a tunnel configuration can specify particular components to be included in a tunnel (e.g., particular imaging modules and structural supports) and particular configurations for these components (e.g., particular arrangement of sub-components, particular spatial orientations, particular software or firmware configurations, etc.). Further, a tunnel configuration can generally include sufficiently specified tunnel parameters to permit a targeted assembly, installation, maintenance, or other operation for a tunnel. Thus, in some examples, a tunnel configuration accordingly can include a fully specified structural configuration of a prospective tunnel (as a whole), a fully specified software configuration of a prospective tunnel (e.g., to enable automated tunnel commissioning, including automated imaging device identification or calibration), or a combination thereof. In different cases, a tunnel configuration can specify a tunnel that is yet to be installed or commissioned or can specify modifications relative to an existing tunnel, each of which can be considered a “prospective tunnel” specified by the relevant tunnel configuration.

Some examples may automatically generate a configuration summary based on a tunnel configuration, i.e., a subset of tunnel parameters or other summarizing information for the tunnel configuration. In some cases, a configuration summary can specify components to be included in a tunnel based on a corresponding tunnel configuration, but at a lesser amount of detail than is provided by the full set of relevant tunnel parameters of the tunnel configuration (e.g., such as with an electronic specification package, as described in greater detail herein). For example, a configuration summary can indicate a type and number of certain components, but not the particular angular orientation, communication ports, spatial location, etc. that are specified for those components in a full tunnel configuration.

In some cases, a configuration summary can include select input parameters from which the tunnel configuration was generated (e.g., select application or site data). In some cases, a configuration summary can present information that is derived from but not necessarily included in a tunnel configuration. For example, a configuration summary can include metrics relating to expected performance of a configured tunnel. In some cases, such metrics or other data in a configuration summary may sometimes be derived from tunnel parameters of a tunnel configuration rather than expressly included therein.

Thus, via automatically generated configuration summaries, some examples can provide operators (e.g., human users) with a more focused, high-level, or otherwise useful presentation of data to evaluate the suitability of particular tunnel configurations, without requiring a particularly detailed review by the operators of a tunnel configuration (e.g., a review of the full set of tunnel parameters in a tunnel configuration). For example, a configuration summary associated with a particular tunnel configuration can be provided as a visual representation that includes a subset of relevant tunnel parameters for a tunnel configuration that may be useful for facilitating operator evaluation of the tunnel configuration.

Some examples may generate dynamic configuration summaries that can be interacted with by operators to adjust or further evaluate a particular tunnel configuration, or to guide operations of a configurator to determine a new tunnel configuration. For example, some dynamic configuration summaries can permit operators to provide operator input to modify select tunnel parameters, input data, or other parameters for a tunnel configuration. The received operator input can then guide subsequent identification, analysis, or presentation of updated or alternative tunnel configurations via, e.g., real-time (or near real-time) updates to a visually-presented dynamic configuration summary. As one example, via the configuration summary, an operator may modify a particular tunnel parameter of a tunnel configuration for a prospective tunnel (e.g., a number of imaging devices in an imaging module). In response, a tunnel configurator can automatically modify the tunnel configuration accordingly, and then generate and transmit a corresponding modified configuration summary to the operator. Thus, for example, an operator can determine and evaluate configuration options for a particular prospective tunnel in real-time or near real-time, and without requiring the operator to apply specialized knowledge, interrogate extensive databases, or perform cumbersome or excessive calculations.

Upon identification of a selected tunnel configuration for a prospective tunnel, some examples described herein may automatically generate and transmit relevant tunnel parameters in particular subsets for further operations. For example, upon approval of a final tunnel configuration by an operator, a tunnel configurator can use the associated tunnel parameters to automatically generate and transmit an electronic specification package for the tunnel configuration, which may include, e.g., a bill of materials report for the tunnel configuration, a tunnel commissioning report for the tunnel configuration, a graphical representation of the tunnel configuration, etc.

In this regard, one example provides a system for generating machine vision tunnel configurations. The system may include one or more electronic processors. The one or more electronic processors may be configured to receive application data for a prospective tunnel. The one or more electronic processors may be configured to determine a first tunnel configuration for the prospective tunnel based on the application data. The one or more electronic processors may be configured to generate and transmit, for display via a user device, a first configuration summary for the first tunnel configuration. The one or more electronic processors may be configured to generate and transmit an electronic specification package based on the first tunnel configuration, wherein the electronic specification package includes a listing of components for the prospective tunnel and a set of commissioning parameters, wherein each component included in the listing of components is associated with at least one commissioning parameter included in the set of commissioning parameters.

In some configurations, the one or more electronic processors may be configured to generate the electronic specification package during a pre-commissioning process prior to installation and commissioning of the prospective tunnel.

In some configurations, the one or more electronic processors may be configured to receive equipment data associated with the prospective tunnel, wherein the first tunnel configuration is determined based on the equipment data and the application data.

In some configurations, the application data may be related to an intended application of the prospective tunnel.

In some configurations, the one or more electronic processors may be configured to determine, based on the application data, a coverage metric for the first tunnel configuration, wherein the first configuration summary includes the coverage metric.

In some configurations, the coverage metric may be a prospective imaging coverage provided by a total field of view (“FOV”) of one or more imaging devices included in the first tunnel configuration.

In some configurations, the coverage metric may include at least one of: a maximum coverage provided by the first tunnel configuration, a coverage used by the first tunnel configuration, an amount of coverage missed by the first tunnel configuration, or an amount of coverage provided when at least one imaging device is removed from the first tunnel configuration.

In some configurations, the one or more electronic processors may be configured to: detect a user interaction with the first configuration summary, wherein the user interaction modifies a tunnel parameter included in the first configuration summary or the application data; and, in response to detecting the user interaction, determine, based on the modified tunnel parameter, a second tunnel configuration for the prospective tunnel, wherein the second tunnel configuration reflects the modified tunnel parameter, generate and transmit to the user device for display, a second configuration summary for the second tunnel configuration, and generate and transmit a second electronic specification package for the second tunnel configuration.

In some configurations, the electronic specification package may include: a bill of materials report for the first tunnel configuration, wherein the bill of materials report includes the listing of components; and a graphical representation of the first tunnel configuration.

In some configurations, the electronic specification package may include a tunnel commissioning package for the first tunnel configuration, where the tunnel commissioning package may include the set of commissioning parameters for the first tunnel configuration and an executable software file that, upon execution during a commissioning process for the prospective tunnel, commissions an imaging device included in the listing of components.

In some configurations, the one or more electronic processors may be configured to generate and transmit the electronic specification package in response to receiving an input corresponding to a user selection of the first tunnel configuration.

In some configurations, the one or more electronic processors may be configured to receive a site data including a constraint for an installation site of the prospective tunnel, where the first tunnel configuration may be determined based on the site data, the application data, and the equipment data.

Another example provides a method of generating machine vision tunnel configurations. The method may include receiving, with one or more electronic processors, application data and site data for a prospective tunnel, and equipment data for a plurality of tunnel components corresponding to the prospective tunnel and including an adjustable imaging module. The method may include determining, with the one or more electronic processors, a first tunnel configuration for the prospective tunnel based on the application data, the site data, and the equipment data, where the first tunnel configuration includes a module configuration for the adjustable imaging module. The method may include automatically generating, with the one or more electronic processors, a first configuration summary of the first tunnel configuration including selected equipment data to specify the module configuration. The method may include, responsive to user input, automatically generating, with the one or more electronic processors, an electronic specification package including at least one of a bill of materials report for the prospective tunnel, a digital representation of the prospective tunnel, or a tunnel commissioning package including a set of commissioning parameters for the prospective tunnel.

In some configurations, the selected equipment parameters specifying the module configuration may include at least one of: a number of imaging devices included in the adjustable imaging module, a pitch for each imaging device included in the adjustable imaging module, a location of the adjustable imaging module on a support structure, or an angular orientation of the adjustable imaging module.

In some configurations, the method may include determining, based on the application data, coverage metrics associated with the first tunnel configuration; and determining whether a coverage metric of the coverage metrics satisfies a coverage threshold, wherein the coverage threshold indicates an amount of over-coverage or under-coverage of a FOV of an imaging device corresponding to the adjustable imaging module, where the first configuration summary may be generated in response to satisfying the coverage threshold, and where the coverage metrics may include an efficiency metric corresponding to the coverage threshold.

In some configurations, the method may include detecting a user interaction with the first configuration summary, where the user interaction modifies a tunnel parameter of the first tunnel configuration; and, in response to detecting the user interaction, determining, based on the modified tunnel parameter, a second tunnel configuration for the prospective tunnel, wherein the second tunnel configuration incorporates the modified tunnel parameter, generating a second configuration summary for the second tunnel configuration, and generating a second electronic specification package for the second tunnel configuration.

In some configurations, the method may include, with the electronic processor, in response to receiving user selection of the first tunnel configuration, generating and transmitting an electronic specification package based on the first tunnel configuration; where generating and transmitting the electronic specification package includes generating and transmitting a tunnel commissioning package for the first tunnel configuration, where the tunnel commissioning package includes a set of commissioning parameters associated with commissioning the prospective tunnel according to the first tunnel configuration.

Another example provides a method for determining configurations for prospective machine vision tunnels. The method may include receiving, with one or more electronic processors, application data for a prospective machine vision tunnel. The method may include determining, based on the application data, with the one or more electronic processors, a first tunnel configuration for the prospective machine vision tunnel. The method may include generating, with the one or more electronic processors, a first configuration summary for the first tunnel configuration. The method may include enabling, with the one or more electronic processors, transmission of the first configuration summary to a user device for display. The method may include generating, with the one or more electronic processors, an electronic specification package based on the first tunnel configuration, the electronic specification package including an executable software file for commissioning one or more components of the prospective machine vision tunnel based on the first tunnel configuration. The method may include enabling, with the one or more electronic processors, transmission of the electronic specification package for commissioning of the prospective machine vision tunnel upon execution of the executable software file.

In some configurations, generating the electronic specification package may include generating at least one of: a graphical representation of the prospective machine vision tunnel based on the first tunnel configuration, a tunnel commissioning package, including the executable software file, or a bill of materials report for the prospective machine vision system based on the first tunnel configuration.

In some configurations, generating the first configuration summary may include generating a dynamic configuration summary reflecting a most-current tunnel configuration version.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1A schematically illustrates an example of a system for capturing multiple images of each side of an object according to aspects of the disclosed technology.

FIG. 1B schematically illustrates an example of a system for capturing multiple images of each side of an object according to aspects of the disclosed technology.

FIG. 2 schematically illustrates another example of a system for capturing multiple images of each side of an object according to aspects of the disclosed technology.

FIG. 3 schematically illustrates another example system for capturing multiple images of each side of an object according to aspects of the disclosed technology.

FIG. 4 is a block diagram illustrating an example system for configuring machine vision tunnels according to aspects of the disclosed technology.

FIG. 5 is a block diagram illustrating components of an example server included in the system of FIG. 4 according to aspects of the disclosed technology.

FIG. 6 is a table illustrating an example set of application inputs according to aspects of the disclosed technology.

FIG. 7 is a table illustrating an example set of site inputs according to aspects of the disclosed technology.

FIG. 8 is a block diagram illustrating various components of an example tunnel configurator application according to aspects of the disclosed technology.

FIG. 9 is a flowchart illustrating a method of configuring machine vision tunnels using the system of FIG. 4 according to aspects of the disclosed technology.

FIGS. 10A and 10B illustrate module configuration parameters for imaging modules implemented as part of the method of FIG. 9 according to aspects of the disclosed technology.

FIG. 11A illustrates example geometric principles implemented as part of the method of FIG. 9 according to aspects of the disclosed technology.

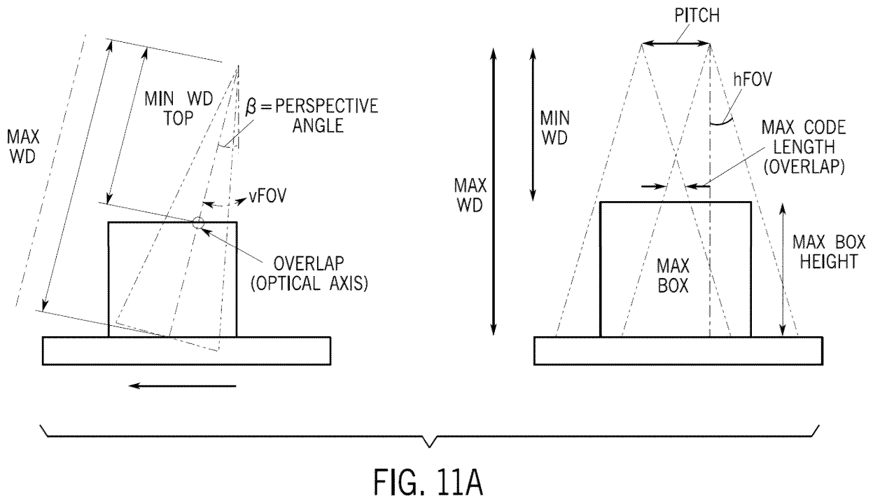

FIG. 11B illustrates example geometric principle implemented as part of the method of FIG. 9 according to aspects of the disclosed technology.

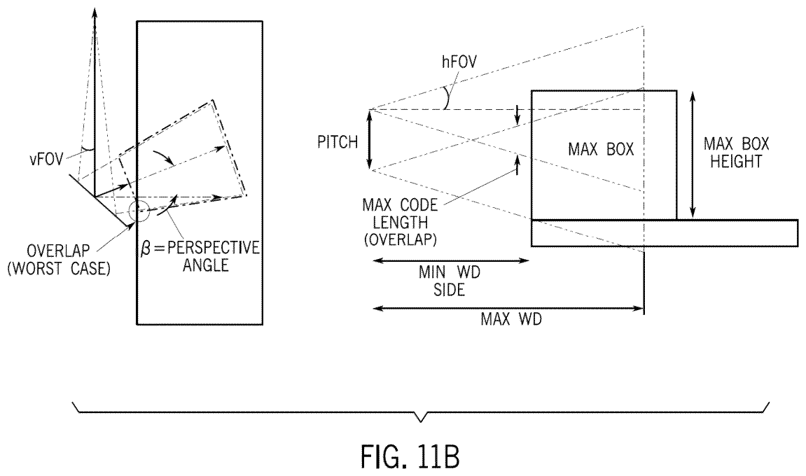

FIG. 12 illustrates an example configuration summary of a tunnel configuration according to aspects of the disclosed technology.

FIG. 13 is a flow diagram illustrating data flow between various components of an example system for configuring machine vision tunnels according to aspects of the disclosed technology.

FIG. 14 a flow diagram illustrating an example process for configuring machine vision tunnels according to aspects of the disclosed technology.

### DETAILED DESCRIPTION OF THE PRESENT DISCLOSURE

Machine vision systems (including one or more imaging devices) are generally designed for use in capturing images of objects or symbols and analyzing the images captured by the machine vision imaging devices. However, prior to implementing a machine vision system (i.e., prior to performing image capture and analysis functionality), the machine vision system may need to be designed according to a specific application (e.g., an intended operation or use of the machine vision system). The design of machine vision systems, including machine vision tunnels, can be dependent on a large number of different parameters associated with the specific application. For machine vision tunnels in logistic applications, these parameters can relevantly include types and sizes of objects to be imaged, types and sizes of conveyors for transporting objects, types and sizes of symbols, such as barcodes, alphanumeric codes, parameters specific to a specific installation site or intended set of operations, and others.

As used herein, “machine vision tunnel” (or simply “tunnel”) may refer to a system that includes and supports one or more imaging devices to acquire imaging data relative to a common scene. In some examples, the common scene is associated with a transport system, for example, a conveyor belt, and in other examples, the common scene is a table or other fixed location where boxes, packages, etc. are placed or passed through the field of view (“FOV”) of the one or more imaging devices (also referred to as a presentation reader). Generally, a scene to be covered by imaging capabilities of a tunnel is defined by the FOV of the imaging devices that are part of the tunnel (e.g., a table-top for presentation of objects for scanning, a discrete section of a conveyor belt or other transport system, etc.). Within a given tunnel, there can be overlap between FOVs of imaging devices, no overlap between FOVs of imaging devices, or a combination thereof (e.g., overlap between certain sets of imaging devices but not between others, collective overlap of multiple imaging devices to cover an entire scene, etc.).

In particular, prior to being installed or operated to perform intended image capture and analysis functionality, some machine vision tunnels may need to be customized to a specific application or site. Relative to particular applications, e.g., a machine vision tunnel may need to be designed to be capable of inspecting objects of particular sizes, weights, or types, performing particular types of image acquisition or analytics (e.g., relative to particular types of symbols, object defects, etc.). In some cases, likewise, a machine vision tunnel may need to comply with any number of required operational metrics (e.g., performance metrics, efficiency metrics, accuracy metrics, etc.) relative to any number of tunnel operations, including identification and decoding of barcodes, or other vision tool operations for identification, gauging, or otherwise inspecting objects or portions thereof. Relative to particular sites, e.g., a machine vision tunnel may need to be designed to accommodate particular spatial constraints (e.g., tunnel mounting surface, available installation space, etc.), or other constraints particular to the location in which the tunnel is to be utilized (e.g., environmental constraints, such as air-quality, temperature, noise, darkness or brightness, etc.).

Conventional approaches to configuring a prospective machine vision tunnel involve an operator manually identifying a complete list of components and configuration parameters that can provide suitable performance for a given site and application. Conventional approaches to configuring a machine visions system can thus involve extensive manual identification and testing of different system configurations, including testing of different quantities and configurations of imaging devices, and of different relationships between imaging devices (e.g., different relative spacing between devices, different locations relative to a transport system or imaging area, or different angular orientations relative to the same). Moreover, significant effort in terms of labor and procurement of different components can be required to test the different system configurations, even once a suitable candidate configuration has been identified. As such, in some situations, these conventional approaches can contribute to inefficiencies in labor, spending, and transport of components, as well as sub-optimal tunnel designs.

Furthermore, conventional approaches may not easily allow for a comparative or tradeoff analysis with respect to one or more prospective tunnel designs. For example, operators may not be able to efficiently identify multiple suitable candidate tunnel configurations using conventional approaches, let alone easily conduct a comparative or tradeoff analysis between different tunnel configurations. Thus, for example, conventional approaches may not be well suited to efficient analysis—and comparative analysis—of the suitability of multiple tunnel configurations, including relative to cost and complexity of the proposed tunnel configuration and the image coverage provided by the proposed tunnel configuration.

In addition, conventional approaches typically do not allow for an operator to easily adjust tunnel parameters such that a tunnel configuration may be suited to a particular tunnel application or site. Thus, as similarly discussed above, operators may not be able to easily modify a particular tunnel configuration to evaluate alternatives to better accommodate a particular optimization target for a particular application or site.

Finally, some conventional processes can be prone to human error and inaccuracies, and can thereby result in inefficient installation and commissioning of machine vision tunnels or other relevant operations. As one example, conventional commissioning processes can lead to variability in performance of a system, inadequate coverage from planned system specifications (e.g., more or less coverage than is actually needed given a precision/accuracy requirement of the application), and increased labor costs. Moreover, potential customers may be dissuaded from installing a complex machine vision system if the process for commissioning such a system becomes too complicated. Systems and methods that can provide improved efficiency in these aspects are generally desired.

In contrast to existing solutions, the present disclosure provides methods and systems that enable optimization at the point of tunnel design (e.g., a pre-commissioning phase or generally before specification, shipping, or installation of tunnel components). Thus, early optimization can streamline commissioning including by avoiding time consuming and complicated tuning operations on site.

Existing processes for designing machine vision tunnels do not approach the problem from a system level. In particular, existing processes fail to optimize system specifications based on network approaches to imaging devices and do not take into account potential cooperative functionality among particular networks of imaging devices for a particular solution. Rather, for example, existing processes provide to installers general angle and placement instructions for individual imaging devices, but provide no specification parameters that extend beyond the physical installment of the tunnel components (e.g., as part of an installation phase). Correspondingly, each imaging device must be independently “tuned” on site (e.g., as part of a commissioning phase). Generally, tuning includes selecting image acquisition parameters (e.g., focus distance, FOV, etc.) based on current environmental conditions (e.g., environmental lighting), which can be time consuming and require expertise. Tuning can take the imaging device out of specification for the overall system, and the success of tuning may be dependent on presenting the correct object in the correct position. Further, tuning involves a physical presence at a customer site with a set of components.

The requirement of on site tuning can also lead to the need to order new components or change existing ones. For example, poor tuning or poor performance after tuning may require system redesign or additional time from expert installers or tunnel designers. Accordingly, approaches that can optimize and specify tunnel systems prior to installation as disclosed herein can improve overall tunnel performance, as well as streamlining installation.

Some examples of the disclosed technology can also allow diagnosis of whether a tunnel has been properly installed or designed. For example, specifications provided using the technology disclosed herein can be used in combination with validation applications to validate installation. In this regard, specifications and other data from some implementations of the disclosed technology can also be used with Similarly, system parameters can be reviewed and optimized during design process to ensure appropriate final design arrangement and functionality.

Further, some examples allow 3D calibration of a tunnel by providing location and other information for imaging devices with respect to the area of interest. This can be useful, for example, for barcode assignment, for runtime dynamic focusing, etc. In this regard, some examples of the disclosed technology can support operation of methods and systems disclosed in International Application No. PCT/US2023/066778, which is incorporated herein by reference).

Accordingly, examples described herein provide methods and systems for configuring machine vision systems (e.g., for tunnels) automatically using a variety of data and with various levels of operator input. In some cases, this functionality can be implemented by a dedicated tunnel configurator software application, or a similar other configurator module. In some cases, this functionality can be implemented as part of a larger machine vision system by a dedicated tunnel configurator module, or can be implemented as a sub-module of a more general purpose machine vision system.

Generally, a tunnel configurator (e.g., a software module or application) can receive as input particular data associated with a particular planned or existing installation for a machine vision tunnel system. For example, the tunnel configurator can receive application data, site data, or equipment data, as further detailed below. Using the data associated with a given installation, and subject to corresponding constraints as further discussed below, the tunnel configurator application can then automatically determine a tunnel configuration (or multiple tunnel configurations) with tunnel parameters to specify equipment and other details for the tunnel configuration. On this basis, the tunnel configurator then also can present one or more potential configurations to an operator for further evaluation or can generate particular sub-sets of tunnel parameters to streamline further operations (e.g., assembling and installing the specified tunnel, commissioning the specified tunnel, etc.).

In some cases, a tunnel configurator can provide dynamic configuration summaries that can dynamically and selectively present particular data to assist operators in efficiently evaluating particular tunnel configurations. Further, some dynamic configurations summaries can facilitate operator input to adjust a tunnel configuration or configuration summary. For example, some dynamic configuration summaries can be presented so as to facilitate operators inputting adjustments to one or more parameters for a configurator (e.g., changes to actual or desired tunnel parameters) and can thereby allow a configurator module, as applicable, to determine and present an updated tunnel configuration (e.g., in an updated dynamic configuration summary). In this regard, for example, some tunnel configurators can perform different analyses to provide, as part of a dynamic configuration summary, application coverage buffers, box distributions, and other tools or data for selecting a particular configuration for a tunnel from many possibilities.

As also noted above, in some implementations, a tunnel configurator can determine a tunnel configuration and can then provide an electronic specification package of select corresponding data for use with other systems or modules. In some cases, a tunnel specification package thus can specify select aspects of a tunnel configuration to inform operations by other relevant software modules to further configure, further evaluate, or support commissioning of a tunnel, or can otherwise provide select tunnel parameters in useful formats for operators or particular other systems (e.g., tunnel designers, tunnel installers, run-time tunnel operators, manufacturing or packing systems, calibration or installation systems, tunnel commissioning systems, etc.). For example, based on analysis of application, site, and equipment data, and as further informed by relevant operator interaction with a dynamic configuration summary, a tunnel configurator can generate and transmit a bill of materials to equip a particular tunnel. As another example, a tunnel configurator can generate and transmit a tunnel specification package for installation (i.e., an installation package) that details installation parameters for a tunnel, including component types, relative or absolute orientations of relevant components, calibration parameters for imaging systems, etc. Similarly, a tunnel configurator can provide a three-dimensional calibration for the machine vision system, or other information to specify the components and configuration of a specified tunnel. As yet another example, the tunnel configurator can generate and provide a tunnel commissioning report or package for the specified tunnel, where the tunnel commissioning package may include one or more executable files for utilization during a commissioning process of the specified tunnel.

A generated bill of materials can be used, for example, to efficiently procure and distribute different components needed to build a machine vision system, as well as to construct a virtual model of the machine vision system, as needed. A tunnel installation package, alone or in combination with a three-dimensional calibration, can be a tunnel commissioning package suitable to support efficient tunnel commissioning (i.e., installing, calibrating, or otherwise getting a specified machine vision system up and running for a given application or site, as further detailed in International Application No. PCT/US2023/066773, which is incorporated herein by reference). Thus, for these and other examples, and as further detailed below, a tunnel configurator can provide efficiency and other improvements for tunnel operations, including by allowing operators to easily customize different parameters associated with a prospective tunnel, evaluate operation of a prospective tunnel before installation or commissioning, arrange for assembly of the relevant components, and implement installation, calibration, or other commissioning operations once a tunnel configuration has been finalized or approved.

In some cases, tunnel parameters can be adjusted to modify imaging coverage. For example, tunnel parameters can indicate how removal of one or more imaging devices from a particular tunnel configuration may affect a resulting tunnel configuration. Correspondingly, some implementations can determine and succinctly present the consequences to imaging coverage that may result from removal of an imaging module or other adjustment (e.g., via image analytics provided by a tunnel configurator).

In this way, for example, operators can more quickly and adaptably determine the effects of potential changes to tunnel configurations, including relative to the precision or accuracy of image acquisition and identification operations by the tunnel. Correspondingly, some implementations can also allow improved tuning of tunnel configurations. For example, analysis of removed imaging devices as discussed above can allow tunnel designers to identify minimum numbers of imaging devices that may be necessary to match the desired performance metrics or otherwise accommodate particular site (or other) requirements. In some instances, such adjustments of the tunnel configuration may occur prior to on-site installation or commissioning of the prospective tunnel.

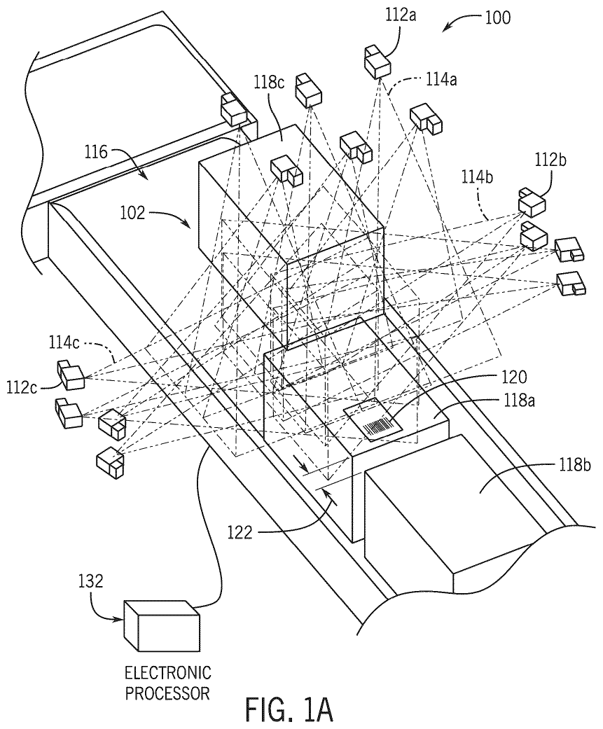

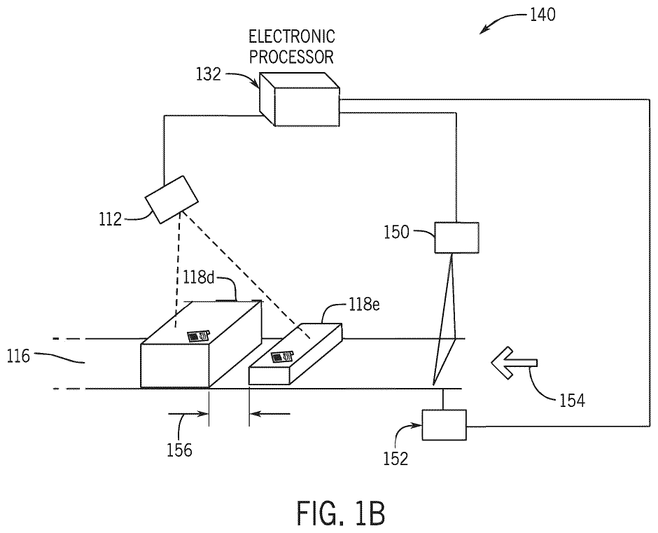

Tunnel configurators and associated functionality, as presented above and detailed below, can be implemented for a wide variety of machine vision systems. In this regard, for example, FIG. 1A illustrates an example of a system 100 for capturing multiple images of each side of an object in accordance with an example of the disclosed technology. In some examples, the system 100 may be configured to evaluate symbols (e.g., one-dimensional barcodes, two-dimensional (“2D”) codes, fiducials, hazmat, alpha-numeric codes, and other labels) on objects 118a, 118b moving through a tunnel 102, such as a symbol 120 on object 118a, including assigning symbols to objects 118a, 118b. In some examples, the symbol 120 is a flat barcode on a top surface of the object 118a, and the objects 118a and 118b are roughly cuboid boxes. Additionally, or alternatively, in some examples, any suitable object geometries are possible for an object to be imaged, and any variety of symbols and symbol locations may be imaged and evaluated, including non-direct part mark (“DPM”) symbols and DPM symbols located on a top or any other side of an object. Alternatively, or in addition, in some examples, a non-symbol recognition approach may be implemented. As one example, some implementations can include a vision-based recognition of non-symbol based features, such as, e.g., one or more edges of an object.

As illustrated in FIG. 1A, the objects 118a and 118b are disposed on a conveyor 116. The conveyor 116 is configured to move the objects 118a and 118b in a direction of travel (e.g., horizontally from left-to-right) through the tunnel 102 at a relatively predictable and continuous rate, or at a variable rate measured by a device, such as, e.g., a motion measurement device or an encoder. Additionally, or alternatively, the objects 118a and 118b may move through the tunnel 102 in other ways (e.g., with non-linear movement). Although the examples described herein are described with respect to a conveyor type transport system, it should be understood that the technology disclosed herein may be implemented with other types of transport systems.

In some examples, the system 100 may include one or more imaging devices 112 and an electronic processor 132 (e.g., a general or special purpose image processing device). As one example, the system 100 may include multiple imaging devices 112 in a tunnel arrangement (e.g., implementing a portion of the tunnel 102), representatively shown via the imaging devices 112a, 112b, and 112c, each with a FOV, representatively shown via FOV 114a, 114b, 114c, that includes part of the conveyor 116. In some examples, each imaging device 112 may be positioned at an angle relative to the conveyor top, bottom, or side (e.g., at an angle relative to a normal direction of symbols on the sides of the objects 118a and 118b or relative to the direction of travel), resulting in an angled FOV. Similarly, some of the FOVs may overlap with other FOVs (e.g., the FOV 114a and the FOV 114b). In such examples, the system 100 may be configured to capture one or more images of multiple sides of the objects 118a or 118b as the objects 118A or 118b are moved by the conveyor 116. In some examples, the captured images may be used to identify symbols on each object (e.g., a symbol 120) or assign symbols to each object, which may be subsequently decoded or analyzed (as appropriate). In some examples, a gap in the conveyor 116 (not shown) may facilitate imaging of a bottom side of an object (e.g., as described in U.S. Patent Application Publication No. 2019/0333259, filed on Apr. 25, 2018, which is hereby incorporated by reference herein in its entirety) using an imaging device or array of imaging devices (not shown), disposed below the conveyor 116.

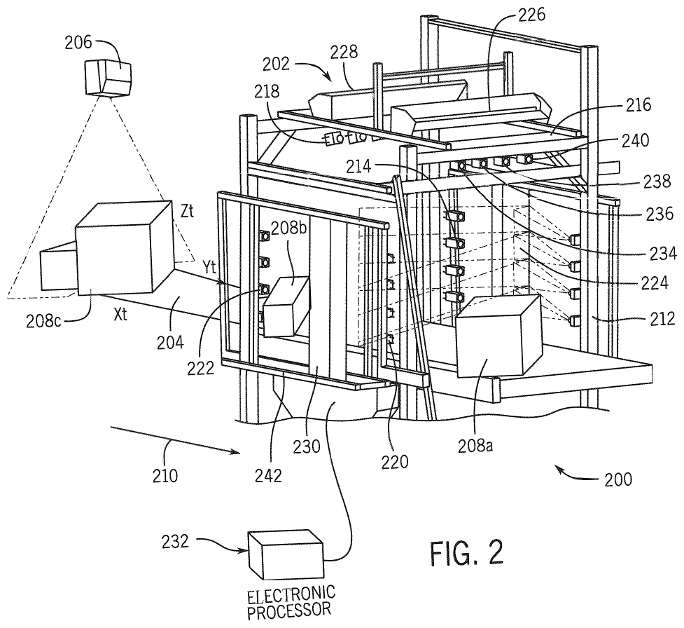

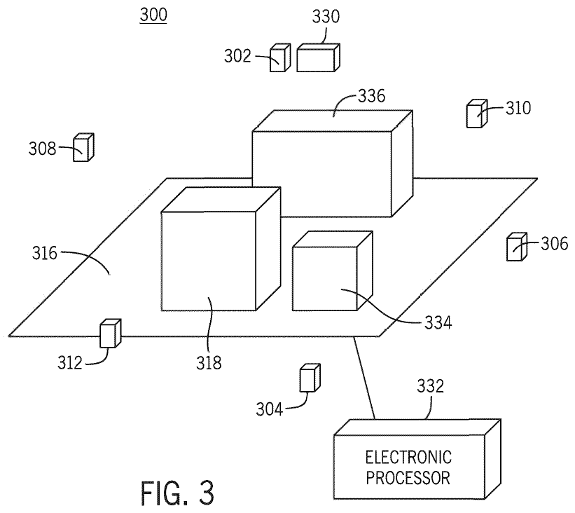

In some examples, the captured images from a bottom side of the object may also be used to identify symbols on the object or assign symbols to each object, which may be subsequently decoded (as appropriate). Note that although two arrays of three imaging devices 112 are shown imaging a top of objects 118a and 118b, and four arrays of two imaging devices 112 are shown imaging sides of objects 118a and 118b, this is merely an example, and any suitable number of imaging devices 112 may be used to capture images of various sides of objects. As one example, each array may include four or more imaging devices 112. Additionally, although the imaging devices 112 are generally shown imaging the objects 118a and 118b without mirrors to redirect a FOV, this is merely one example, and one or more fixed or steerable mirrors may be used to redirect a FOV of one or more of the imaging devices 112 as described below with respect to FIGS. 2 and 3, which may facilitate a reduced vertical or lateral distance between the imaging devices 112 and the objects 118a, 118b in the tunnel 102. For example, the imaging device 112a may be disposed with an optical axis parallel to the conveyor 116, and one or more mirrors may be disposed above the tunnel 102 to redirect a FOV from the imaging device 112a toward a front and top of the objects 118a, 118b in the tunnel 102.

In some examples, the imaging devices 112 may be implemented using any suitable type of imaging device(s). As one example, the imaging devices 112 may be implemented using 2D imaging devices (e.g., 2D imaging devices), such as area scan imaging devices or line scan imaging devices. In some examples, the imaging device 112 may be an integrated system that includes a lens assembly and an imager, such as a CCD or CMOS sensor. In some examples, the imaging devices 112 may each include one or more image sensors, at least one lens arrangement, and at least one control device (e.g., an electronic processor device) configured to execute computational operations relative to the image sensor. Each of the imaging devices 112a, 112b, or 112c may selectively acquire image data from different FOVs, regions of interest (“ROIs”), or a combination thereof. In some examples, the system 100 may be utilized to acquire multiple images of each side of an object where one or more images may include more than one object. The multiple images of each side may be used to assign a symbol in an image to an object in the image. The object 118a, 118b, 118c may be associated with one or more symbols, such as a barcode, a QR code, etc. In some examples, the system 100 may be configured to facilitate imaging of the bottom side of an object supported by the conveyor 116 (e.g., the side of the object 118a, 118b, 118c resting on the conveyor 116). As one example, the conveyor 116 may be implemented with a gap, such as a gap between sections of the conveyor 116 (as also discussed above).

In some examples, an inter-object gap 122 is provided between objects 118a, 118b. In different implementations, gaps between objects may range in size. In some implementations, gaps between objects may be substantially the same between all sets of objects in a system, or may exhibit a fixed minimum size for all sets of objects in a system. In some examples, smaller gap sizes may be used to maximize system throughput.

FIG. 1B shows an example of a system 140 for capturing multiple images of each side of an object 118d, 118e in accordance with an example of the disclosed technology (e.g., as a specific implementation of the system 100). FIG. 1B shows a simplified diagram of the system 140 to illustrate an example arrangement of a three-dimensional (3D) measurement system 150, referred to herein as a dimensioner, and a motion measurement device 152 (e.g., an encoder) with respect to a tunnel. In the illustrated example, the conveyor 116 is configured to move the objects 118d, 118e along the direction indicated by arrow 154 past the dimensioner 150 before the objects 118d, 118e are imaged by one or more imaging devices 112. In the illustrated example, a gap 156 is provided between objects 118d and 118e. The electronic processor 132 may be in communication with the imaging devices 112, the dimensioner 150, and the motion measurement device 152, also referred to herein as an encoder.

The dimensioner 150 may be configured to determine dimensions or a location of an object supported by the conveyor 116 or other support structure at a certain point in time (e.g., the object 118d or 118e). As one example, the dimensioner 150 may be configured to determine a distance from the dimensioner 150 to a top surface of the object 118d, 118e, and may be configured to determine a size or orientation of a surface facing the dimensioner 150. In some examples, the dimensioner 150 may be implemented using various technologies. The dimensioner 150 may be implemented, for example, using a 3D imaging device a structured light 3D imaging device, a continuous time of flight 3D imaging device, a time-of-flight sensor or computed from stereo images, etc. As another example, the dimensioner 150 may be implemented using a laser scanning system (e.g., a LiDAR system). In a particular example, the dimensioner 150 may be implemented using a 3D-A1000 system available from Cognex Corporation. In some examples, the dimensioner 150 may be implemented in a single device or enclosure with an imaging device 112 or the electronic processor 132. In some examples, the imaging device 112 may also be implemented in a device with both the dimensioner 150 and the electronic processor 132.

In some examples, the dimensioner 150 may determine 3D coordinates of each corner of the object 118d, 118e in a coordinate space defined with reference to one or more portions of the system 140. As one example, the dimensioner 150 may determine 3D coordinates of each of eight corners of an object 118d, 118e that is at least roughly cuboid in shape within a Cartesian coordinate space defined with an origin at the dimensioner 150. As another example, the dimensioner 150 may determine 3D coordinates of each of eight corners of an object 118d, 118e that is at least roughly cuboid in shape within a Cartesian coordinate space defined with respect to the conveyor 116 (e.g., with an origin that originates at a center of the conveyor 116).

In some examples, the encoder 152 may be linked to the conveyor 116 and the imaging devices 112 to provide electronic signals to the imaging devices 112 or the electronic processor 132 that indicate the amount of travel of the conveyor 116, and the objects 118d, 118e supported thereon, over a known amount of time. This may be useful, for example, in order to coordinate capture of images of particular objects (e.g., the objects 118d, 118e), based on calculated locations of the object 118d, 118e relative to a field of view of a relevant imaging device (e.g., the imaging device(s) 112). In some examples, the encoder 152 may be configured to generate a pulse count (e.g., an encoder pulse count) that may be used to identify the position of the conveyor 116 along the direction of travel (e.g., the direction of the arrow 154). As one example, the encoder 152 may provide a pulse count (e.g., an encoder pulse count) to the electronic processor 132 for identifying and tracking the positions of objects (e.g., the objects 118d, 118e) on the conveyor 116. In some examples, the encoder 152 may increment a pulse count (e.g., an encoder pulse count) each time the conveyor 116 moves a predetermined distance (as a pulse count distance) in the direction of the arrow 154. In some examples, a position of an object 118d, 118e may be determined based on an initial position, the change in the pulse count, and the pulse count distance.

In some examples, the electronic processor 132 (or a control device) may coordinate operations of various components of the system 100 (or 140). For example, the electronic processor 132 may control a dimensioner 150 to acquire dimensions of an object positioned on the conveyor 116 and may cause the imaging devices 112 to capture images of each side. In some examples, the electronic processor 132 may control detailed operations of each imaging device, for example, by providing trigger signals to cause the imaging device 112 to capture images at particular times, etc. Alternatively, or in addition, in some examples, the electronic processor 132 may configure other devices to acquire images with different parameters (as opposed to typical production operation parameters). Alternatively, in some examples, another device (e.g., an electronic processor included in each imaging device 112, a separate controller device, etc.) may control detailed operations of each imaging device 112. As one example, the electronic processor 132 (or any other suitable device) may provide a trigger signal to each imaging device 112 or dimensioner 150, and an electronic processor of each imaging device 112 may be configured to implement a predesignated image acquisition sequence that spans a predetermined region of interest in response to the trigger.

The system 100 (or 140) may also include one or more light sources (not shown) to illuminate surfaces of an object 118. Operation of such light sources may also be coordinated by a central device (e.g., the electronic processor 132), or control may be decentralized (e.g., an imaging device 112 may control operation of one or more light sources, an electronic processor associated with one or more light sources may control operation of the light sources, etc.). As one example, in some examples, the system 100 (or 140) may be configured to concurrently (e.g., at the same time or over a common time interval) acquire images of multiple sides of an object 118, including as part of a single trigger event. As one example, each imaging device 112 may be configured to acquire a respective set of one or more images over a common time interval. Additionally, or alternatively, in some examples, the imaging devices 112 may be configured to acquire the images based on a single trigger event. As one example, based on a sensor (e.g., a contact sensor, a presence sensor, an imaging device 112, etc.) determining that the object 118 has passed into the FOV of the imaging devices 112, the imaging devices 112 may concurrently acquire images of the respective sides of the object 118.

As mentioned above, one or more fixed or steerable mirrors may be used to redirect a FOV of one or more of the imaging devices 112, which may facilitate a reduced vertical or lateral distance between imaging devices 112 and the object(s) 118 in the tunnel 102. FIG. 2 illustrates another example of a system 200 for capturing multiple images of each side of an object 208a, 208b in accordance with an example of the disclosed technology (e.g., as a specific implementation of the system 100). The system 200 includes multiple banks of imaging devices 212, 214, 216, 218, 220, 222 and multiple mirrors 224, 226, 228, 230 in a tunnel arrangement 202. As one example, the banks of imaging devices illustrated in FIG. 2 include a left trail bank 212, a left lead bank 214, a top trail bank 216, a top lead bank 218, a right trail bank 220, and a right lead bank 222. In the illustrated example, each bank 212, 214, 216, 218, 220, 222 includes four imaging devices that are configured to capture images of one or more sides of an object (e.g., the object 208a) and various FOVs of the one or more sides of the object 208a, 208b. As one example, the top trail bank 216 and the mirror 228 may be configured to capture images of the top and back surfaces of the object 208a using the imaging devices 234, 236, 238, and 240. In the illustrated example, the banks of imaging devices 212, 214, 216, 218, 220, 222 and the mirrors 224, 226, 228, 230 may be mechanically coupled to a support structure 242 above a conveyor 204.

Note that although the illustrated mounting positions of the banks imaging devices 212, 214, 216, 218, 220, 222 relative to one another may be advantageous, in some examples, imaging devices for imaging different sides of an object may be reoriented relative to the illustrated positions in FIG. 2 (e.g., imaging devices may be offset, imaging devices may be placed at the corners, rather than the sides, etc.). Similarly, while there may be advantages associated with using four imaging devices per bank that are each configured to acquire image data from one or more sides of an object, in some examples, a different number or arrangement of imaging devices, a different arrangement of mirror (e.g., using steerable mirrors, using additional fixed mirrors, etc.) may be used to configure a particular imaging device to acquire images of multiple sides of an object. In some examples, an imaging device may be dedicated to acquiring images of multiple sides of an object including with overlapping acquisition areas relative to other imaging devices included in the same system.

In some examples, the system 200 also includes a dimensioner 206 and an image processing device 232. As discussed above, multiple objects 208a, 208b and 208c may be supported in the conveyor 204 and travel through the tunnel 202 along a direction indicated by arrow 210. In some examples, each bank of imaging devices 212, 214, 216, 218, 220, 222 (and each imaging device in a bank) may generate a set of images depicting a FOV or various FOVs of a particular side or sides of an object supported by the conveyor 204 (e.g., the object 208a).

Note that although FIGS. 1A-1B and 2 depict a dynamic support structure (e.g., the conveyor 116, the conveyor 204) that is moveable, in some examples, a stationary support structure may be used to support objects to be imaged by one or more imaging devices. In some examples (not shown) the objects to be imaged can be passed through the coverage area by an operator temporarily until the desired vision operations have been completed. FIG. 3 shows another example system for capturing multiple images of each side of an object in accordance with an example of the disclosed technology (e.g., as a specific implementation of the system 100). In some examples, the system 300 may include multiple imaging devices 302, 304, 306, 308, 310, and 312, which may each include one or more image sensors, at least one lens arrangement, and at least one control device (e.g., a processor device) configured to execute computational operations relative to the image sensor. In some examples, imaging devices 302, 304, 306, 308, 310, or 312 may include or be associated with a steerable mirror. For example, some imaging devices can be configured for use with steerable mirrors as described in U.S. patent application Ser. No. 17/071,636, filed on Oct. 13, 2020, which is hereby incorporated by reference herein in its entirety. Each of the imaging devices 302, 304, 306, 308, 310, or 312 may selectively acquire image data from different FOVs, corresponding to different orientations of the associated steerable mirror(s). In some examples, the system 300 may be utilized to acquire multiple images of each side of an object.

In some examples, the system 300 may be used to acquire images of multiple objects presented for image acquisition. As one example, the system 300 may include a support structure (not shown) that supports each of the imaging devices 302, 304, 306, 308, 310, 312 and a support platform 316 configured to support one or more objects 318, 334, 336 to be imaged (note that each object 318, 334, 336 may be associated with one or more symbols, such as a barcode, a QR code, etc.). In some examples, the support structure may be configured as a caged support structure. However, this is merely an example, and the support structure may be implemented in various configurations. In some examples, the support platform 316 may be configured to facilitate imaging of the bottom side of one or more objects supported by the support platform 316 (e.g., the side of an object 318, 334, or 336 resting on the platform 316). As one example, the support platform 316 may be implemented using a transparent platform, a mesh or grid platform, an open center platform, or any other suitable configuration. Other than the presence of the support platform 316, acquisition of images of the bottom side can be substantially similar to acquisition of other sides of the object. As a further example, a transport system (not shown), including one or more robot arms (e.g., a robot bin picker), may be used to position multiple objects (e.g., in a bin or other container) on the support platform 316.

In some examples, the imaging devices 302, 304, 306, 308, 310, or 312 may be oriented such that a FOV of the imaging device may be used to acquire images of a particular side of an object resting on the support platform 316, such that each side of an object (e.g., the object 318) placed on and supported by the support platform 316 may be imaged by the imaging devices 302, 304, 306, 308, 310, or 312. As one example, the imaging device 302 may be mechanically coupled to the support structure above the support platform 316, and may be oriented toward an upper surface of support platform 316, the imaging device 304 may be mechanically coupled to the support structure below the support platform 316, and the imaging devices 306, 308, 310, or 312 may each be mechanically coupled to a side of the support structure, such that a FOV of each of the imaging devices 306, 308, 310, or 312 faces a lateral side of the support platform 316.

In some examples, each imaging device may be configured with an optical axis that is generally parallel with another imaging device, and perpendicular to other imaging devices (e.g., when the steerable mirror is in a neutral position). As one example, the imaging devices 302 and 304 may be configured to face each other (e.g., such that the imaging devices 302 and 304 have substantially parallel optical axes), and the other imaging devices may be configured to have optical axis that are orthogonal to the optical axis of the imaging devices 302 and 304.

Note that although the illustrated mounting positions of the imaging devices 302, 304, 306, 308, 310, and 312 relative to one another may be advantageous, in some examples, imaging devices for imaging different sides of an object may be reoriented relative the illustrated positions of FIG. 3 (e.g., imaging device may be offset, imaging devices may be placed at the corners, rather than the sides, etc.). Similarly, while there may be advantages (e.g., increased acquisition speed) associated with using six imaging devices that is each configured to acquire imaging data from a respective side of an object (e.g., the six side of the object 118), in some examples, a different number or arrangement of imaging devices, a different arrangement of mirrors (e.g., using fixed mirrors, using additional moveable mirrors, etc.) may be used to configure a particular imaging device to acquire images of multiple sides of an object. As one example, fixed mirrors disposed such that the imaging devices 306 and 310 may capture images of a far side of the object 318 and may be used in lieu of the imaging devices 308 and 312. In some examples, the system 300 may be configured to image each of the multiple objects 318, 334, 336 on the platform 316.

In some examples, the system 300 may include a dimensioner 330. As described above with respect to FIGS. 1A, 1B and 2, the dimensioner 330 may be configured to determine dimensions or a location of an object supported by the support structure 316 (e.g., the object 318, 334, or 336). As mentioned above, in some examples, the dimensioner 330 may determine 3D coordinates of each corner of the object in a coordinate space defined with reference to one or more portions of the system 300. As one example, the dimensioner 330 may determine 3D coordinates of each of eight corners of an object that is at least roughly cuboid in shape within a Cartesian coordinate space defined with an origin at the dimensioner 330. As another example, the dimensioner 330 may determine 3D coordinates of each of eight corners of an object that is at least roughly cuboid in shape within a Cartesian coordinate space defined with respect to the support platform 316 (e.g., with an origin that originates at a center of the support platform 316).

In some examples, an image processing device 332 may coordinate operations of the imaging devices 302, 304, 306, 308, 310, or 312 or may perform image processing tasks as described above in connection with the electronic processor 132 of FIG. 1A.

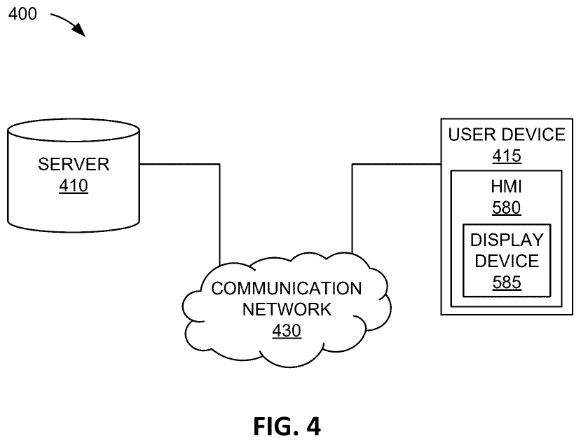

FIG. 4 schematically illustrates a system 400 for generating machine vision configurations according to some examples, including as can be used to generate and utilize tunnel configurations for different sites and applications (e.g., to specify part or all of any of the systems 100, 140, 200, 300 discussed above). In the illustrated example, the system 400 includes a server 410 and a user device 415. In some examples, the system 400 includes fewer, additional, or different components in different configurations than illustrated in FIG. 4. As one example, the system 400 may include multiple servers 410, multiple user devices 415, or a combination thereof. As another example, one or more components of the system 400 may be combined into a single device, such as, e.g., the server 410 and the user device 415.

The server 410 and the user device 415 communicate over one or more wired or wireless communication networks 430. Portions of the communication networks 430 may be implemented using a wide area network, such as the Internet, a local area network, such as a Bluetooth™ network or Wi-Fi, and combinations or derivatives thereof. Alternatively, or in addition, in some examples, components of the system 400 communicate directly as compared to through the communication network 430. Also, in some examples, the components of the system 400 communicate through one or more intermediary devices not illustrated in FIG. 4.

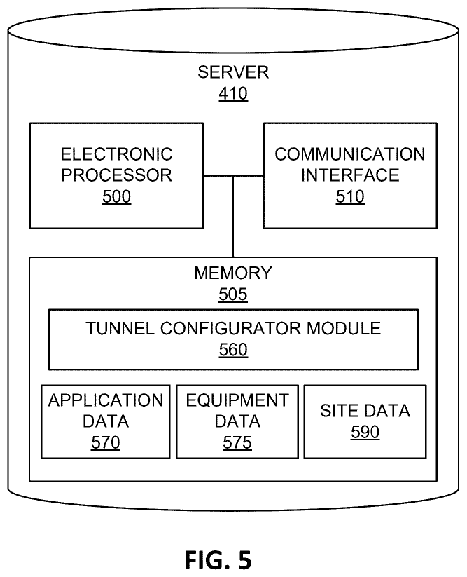

The server 410 is generally a computing module, such as a general purpose server device, a database system, or the like. As illustrated in FIG. 5, the server 410 includes an electronic processor 500, a memory 505, and a communication interface 510, as well as a tunnel configurator module 560 and application, equipment, and site data 570, 575, 590 as further discussed below. The electronic processor 500, the memory 505, and the communication interface 510 communicate wirelessly, over one or more communication lines or buses, or a combination thereof. The server 410 may include additional components than those illustrated in FIG. 5 in various configurations. As one example, the server 410 may also communicate with or include one or more human machine interfaces, such as a keyboard, keypad, mouse, joystick, touchscreen, display device, printer, speaker, and the like, that receive input from an operator, provide output to an operator, or a combination thereof. The server 410 may also perform additional functionality other than the functionality described herein. Also, the functionality described herein as being performed by the server 410 may be distributed among multiple servers or devices (e.g., as part of a cloud service or cloud-computing environment), combined with another component of the system 400 (e.g., combined with the user device 415 another component of the system 400, or the like), or a combination thereof.

The communication interface 510 may include a transceiver that communicates with the user device 415 over the communication network 430 and, optionally, one or more other communication networks or connections. Returning to FIG. 4, the user device 415 may be a computing device, such as a desktop computer, a laptop computer, a tablet computer, a terminal, a smart telephone, a smart television, a smart wearable, or another suitable computing device that can be interfaced with by an operator. Although not illustrated in FIG. 4, the user device 415 may include similar components as the server 410, such as an electronic processor (e.g., a microprocessor, an application-specific integrated circuit (“ASIC”), or another suitable electronic device), a memory (e.g., a non-transitory, computer-readable storage medium), a communication interface, such as a transceiver, for communicating over the communication network 430 and, optionally, one or more additional communication networks or connections. For example, to communicate with the server 410 (or another component of the system 400), the user device 415 may store a browser application or a dedicated software application executable by an electronic processor.

The system 400 is described herein as providing a tunnel configuration service through the server 410. However, in other configurations, the functionality (or a portion thereof) described herein as being performed by the server 410 may be locally performed by the user device 415. As one example, in some cases, the user device 415 may store the software applications and other data (e.g., as further discussed relative to FIG. 5, below). As described in greater detail herein, an operator may use the user device 415 to configure a tunnel, including via engagement with a configuration summary or other data provided by the configurator module 560.

In the illustrated example of FIG. 4, the user device 415 may also include a human-machine interface (“HMI”) 580 for interacting with an operator. The HMI 580 may include one or more input devices, one or more output devices, or a combination thereof. Accordingly, in some configurations, the HMI 580 allows an operator to interact with (e.g., provide input to and receive output from) the user device 415. For example, the HMI 580 may include a keyboard, a cursor-control device (e.g., a mouse), a touch screen, a scroll ball, a mechanical button, a display device (e.g., a liquid crystal display (“LCD”)), a printer, a speaker, a microphone, or a combination thereof. As illustrated in FIG. 4, in some cases, the HMI 580 includes a display device 585. The display device 585 may be included in the same housing as the user device 415 or may communicate with the user device 415 over one or more wired or wireless connections. For example, in some configurations, the display device 585 is a touchscreen included in a laptop computer or a tablet computer. In other configurations, the display device 585 is a monitor, a television, or a projector coupled to a terminal, desktop computer, or the like via one or more cables.

Referring again to FIG. 5, the electronic processor 500 includes a microprocessor, an ASIC, or another suitable electronic device for processing data, and the memory 505 includes a non-transitory, computer-readable storage medium. The electronic processor 500 is generally configured to retrieve instructions and data from the memory 505 and execute the instructions. For example, as illustrated in FIG. 5, the memory 505 includes the tunnel configurator module 560 (also referred to herein as “configurator 560”). The configurator 560 is a software application executable by the electronic processor 500 in the example illustrated (e.g., as further discussed below), although a similarly purposed module can be implemented in other ways in other examples (e.g., as a dedicated hardware module, etc.). As described in more detail below, the electronic processor 500 executes the configurator 560 to assist in configuring a prospective tunnel, and, more specifically, to generate one or more corresponding electronic tunnel specification packages (e.g., a bill of materials report, a tunnel commissioning package or report, and the like) or other tunnel data to assist operators in designing, procuring, installing, and commissioning a tunnel.

In general, the configurator 560 may assist in configuring a prospective tunnel based on various input data. For example, input (or other) data for the configurator 560 can include data represented schematically as the application data 570, the equipment data 575, and the site data 590 in FIG. 5, which can be constituted by particular application, equipment, and site parameters, respectively. In other examples, some or all of these data can be combined together. For example, the application and site data 570, 590 can be treated as a collective part of customer requirement data (not shown) in some cases, rather than as distinct categories of data. Generally, application parameters included in the application data 570 can be associated with a particular operational context of a prospective tunnel. Likewise, equipment parameters included in the equipment data 575 can be associated with equipment for the tunnel, and site parameters included in the site data 590 can be associated with constraints or other factors that are particular to a location for a tunnel. For example, the application data 570 can specify operational requirements for a particular type of scanning operation, the equipment data 575 can specify types or configurations of available equipment, and the site data 590 can specify spatial boundaries or other related constraints for a tunnel or components thereof.

As illustrated in FIG. 5, the application data 570, the equipment data 575, the site data 590, or a combination thereof may be locally stored in the memory 505. However, alternatively or in addition, in some configurations, the application data 570, the equipment data 575, the site data 590, or a combination thereof may be remotely stored, such as, e.g., in a memory of the user device 415, one or more databases, another remote device or system, or the like.

Continuing from the examples above, the application data 570 may include data or parameters associated with a specific application of a tunnel. For example, the application data 570 may include parameters specific to an intended operation or tasks to be performed by the prospective tunnel after the prospective tunnel is installed and commissioned on site. The application data 570 may include data that specifies particular image acquisition or analysis capabilities that may be required for a prospective tunnel. For example, the application data 570 may be customer application data that is specific to a customer's intended application of a prospective tunnel and may correspondingly specify particular types of or requirements for logistics processing in a tunnel (e.g., as further specified by the site data 590 relative particular physical location or environment for the customer). Thus, for example, the application data 570 may include an image coverage, product information (e.g., data associated with a product or object that may be transported by the prospective tunnel after the tunnel is installed or commissioned), symbology information, conveyor information, rate information (e.g., a required speed of scanning or product identification), and the like.

Further in this regard, symbology information included in the application data 570 may indicate the type of symbol, i.e., code, that the barcode readers will be decoding. The symbology information may thus include, e.g., a module size (e.g., a smallest feature in a machine readable symbol, such as a thinnest line in a barcode), a maximum symbol size (e.g., a maximum symbol width, a maximum symbol length, and the like), a symbology type (e.g., a one-dimensional symbol type, a 2D symbol type, etc.), a symbol orientation, a symbol justification, and the like.

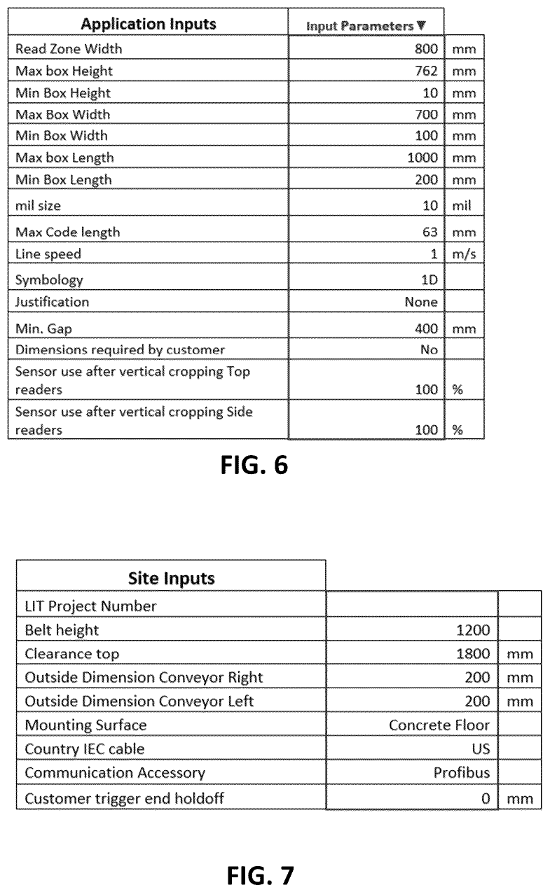

Similarly, the conveyor information included in the application data 570 may be information associated with one or more conveyors that may be used with the tunnel. For example, conveyor information may include a conveyor width, a maximum object height, a minimum object height, a minimum object width, a maximum object width, a minimum object length, a maximum object length, a conveyor speed (e.g., a speed at which an object on the conveyor 116 moves), a justification (e.g., of an object moving along the conveyor 116), a minimum inter-object gap (e.g., a minimum distance between objects on the conveyor 116), a spatial (e.g., 3D volume) boundary or other characterization of a read zone for acquiring images for analysis, or the like. FIG. 6 is a table illustrating one example set of application inputs, one or more of which can be included as part of the application data 570 of FIG. 5.

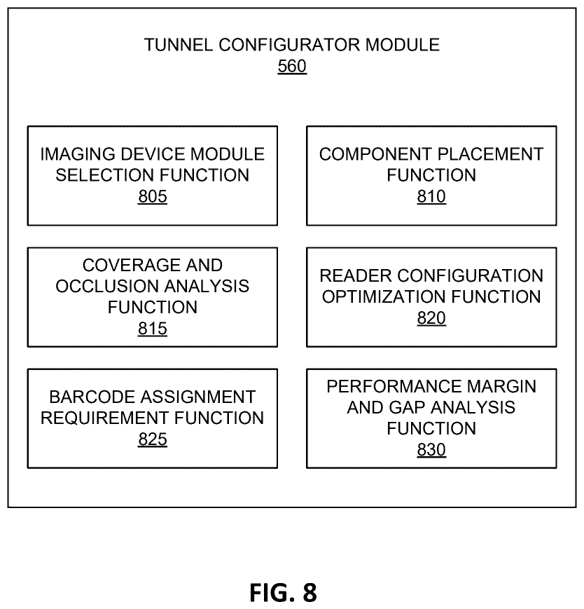

As also noted above, the site data 590 may generally include parameters that specify constraints or other requirements for a tunnel that are particular to a location in which a tunnel is to be commissioned (e.g., rather than to a particular machine vision application to be implemented at the site). For example, the site data 590 can include height or other spatial parameters for a conveyor height, height or side clearance parameters relative to facility structures at a top or to the side of a tunnel or conveyor, spatial or other characteristics of a mounting surface (e.g., material information to designate a concrete, wood, grid, I-beam, or other support structure), electronic compatibility information (e.g., to indicate a an International Electrotechnical Commission (“IEC”) cable, or a country-specific power or other connection), a relevant communication system or corresponding communication protocol, a customer trigger end holdoff (e.g., a distance at the end of each trigger during which if an incoming signal is received, that incoming signal will be ignored to smooth out signal noise), other data specific to a site of a tunnel, or a combination thereof. FIG. 7 is a table illustrating one example set of site inputs, one or more which can be included as part of the application data 570 of FIG. 5.

The equipment data 575 may include data or parameters associated with one or more components or devices of a prospective tunnel, such as, e.g., one or more imaging devices, dimensioners, conveyors, support structures, or the like. For example, the equipment data 575 may include a listing of available tunnel components, including as inventory data indicating particular models or configurations of imaging devices and related components (e.g., fixed or steerable mirrors, lens assemblies, support brackets, etc.). In some examples, equipment data 575 also include operational parameters or information associated with available tunnel components, including, e.g., a reading range, a FOV for imaging, illumination variant, imaging device PIN, filters, power input/output devices, dimensioners, or other image acquisition parameters for an imaging device.

Alternatively, or in addition, the equipment data 575 may include information associated with one or more possible module configurations for imaging modules. As also generally discussed herein, for example, imaging modules can include fixed or adjustable brackets to collectively support one or more imaging devices, one or more lighting assemblies, one or more fixed or movable mirrors, etc. Thus, for example, the equipment data 575 may indicate a number of imaging devices per imaging module, a pitch for multiple imaging devices (i.e., a nearest spacing between optical axes), an angle of an imaging device relative to a particular reference frame (e.g., relative to a support bracket, mirror, or other imaging device), an angle or other characteristic of a mirror for image acquisition, an orientation or illumination setting for a lighting assembly, etc. Further details regarding adjustable imaging modules are included in U.S. patent application Ser. No. 17/894,848, which is incorporated herein by reference.

In some cases, components of imaging modules (e.g., imaging devices, mirrors, etc.) can be adjustable to allow imaging modules to be readily customizable to a particular relative spacing and corresponding imaging arrangement. For example, in some implementations of adjustable imaging modules, including when an imaging device is to be used for a different application, the orientation of a first imaging device, a first mirror, and a first illumination source relative to a first bracket structure can be adjusted to accommodate for different factors of the application, and the orientation of the a imaging device, a second mirror, and a second illumination source relative to a second bracket can also be adjusted accordingly. In other words, for an application for the imaging system 100, an adjustable imaging module can have each of its components (e.g., a imaging device, a mirror, a illumination source, etc.) in a predetermined orientation relative its respective bracket structures according to the application. Accordingly, in some instances, the equipment data 573 may identify or include one or more predetermined or predefined parameters, arrangements, module configurations, etc. Further, in some instances, such predetermined or predefined parameters, arrangements, module configurations, etc. may be determined based on an intended application or site for the prospective tunnel (e.g., the application data 570, the site data 590, or the like). For example, the predetermined or predefined parameters, arrangements, module configurations, etc. may be determined such that one or more constraints or requests included in the application data 570, the site data 590, or a combination thereof is satisfied.

Further, some equipment data 575 may indicate options for one or more (e.g., all) of these or other parameters (e.g., a range of potential numbers of imaging devices, of pitches for those devices, of angular orientations of imaging devices and adjustable mirrors, etc.). In some instances, an imaging module configuration may be a predefined module configuration, or may be included in a set of predefined module configurations. In some cases, the equipment data 575 can include a set of module configurations, each of which may indicate a different possible configuration of an imaging module, and may specify the construction and imaging capabilities thereof. For example, different module configurations of a set of modules configurations can specify different imaging modules relative to: a quantity and type of a support system (e.g., particular support bracket); a quantity and type of included imaging devices, along with a corresponding orientation and pitch information (as applicable); a quantity and type of included illumination systems, along with corresponding orientation and pitch information (as applicable); a quantity and type of fixed or other mirrors, along with corresponding orientation and pitch information (as applicable), etc.

In some cases, the equipment data 575 can include data specifying a range of possible configurations for an adjustable imaging module. As also noted herein, some imaging modules can be configured to allow angular or other adjustments of particular components to provide a range of imaging configurations. For example, some imaging modules can allow easy adjustment of an angular orientation of an imaging device between multiple discrete (or continuous) orientations, or similar adjustment of a mirror assembly or an illumination system. Thus, in some cases, the equipment data 575 can include parameters to specify a range of imaging configurations for each of multiple imaging modules (e.g., relative to particular configuration parameters as also discussed herein).

In some configurations, the configurator 560 receives a tunnel configuration request associated with a tunnel and accesses the application data 570, the equipment data 575, the site data 590, or a combination thereof to generate a tunnel configuration and corresponding specification packages. For example, the configurator 560 may generate a particular tunnel configuration for a prospective tunnel and may also generate a bill of materials report, or other specification packages for transmission to other software applications or relevant tunnel configuration or commissioning modules.

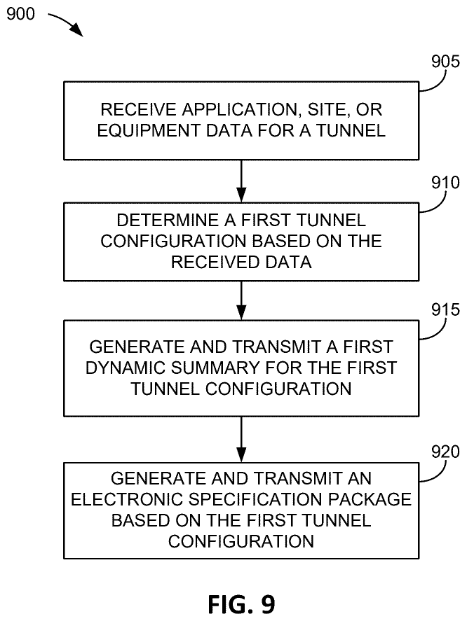

In this regard, in some configurations, the configurator 560 includes a set of functions that can be individually or collectively implemented in order to generate possible tunnel configurations or otherwise assist an operator to configure a tunnel. As one example, FIG. 8 illustrates a set of functions, which may be included as part of the configurator 560 according to some configurations. As illustrated in FIG. 8, the set of functions may include an imaging device module selection function 805, a component placement function 810, a coverage and occlusion analysis function 815, a reader configuration optimization function 820, a barcode assignment requirement function 825, and a performance margin and gap analysis function 830. The configurator 560 may include fewer, additional, or different functions in different configurations than illustrated in FIG. 8. Alternatively, or in addition, in some instances, one or more of the functions may be distributed among multiple functions, combined into a single function, or a combination thereof.

The imaging device module selection function 805 may select one or more imaging device modules for a prospective tunnel. In some instances, the imaging device module selection function 805 may select one or more imaging device modules for a prospective tunnel based on, e.g., the application data 570, the equipment data 575, the site data 590, other tunnel data, or a combination thereof. For example, the input data (e.g., the data 570, 575, 590) can designate requirements regarding FOV, lighting, resolution, working distance, pitch, angular orientation, or other imaging parameters for one or more imaging device modules (e.g., one or more imaging device modules that are adjustable relative to those variables), as can inform selection of a particular imaging device module by the imaging device module selection function 805.

The component placement function 810 may determine a set of positions or placements for components of the prospective tunnel. In some configurations, the component placement function 810 determines the set of positions based on an output of the imaging device module selection function 805, another function performed by the configurator 560, or a combination thereof. As one example, the component placement function 810 may determine a placement of each imaging device included in a selected imaging device module (as an output of the imaging device module selection function 805). In some instances, the component placement function 810 determines a position or placement of one or more other components of the tunnel based on, e.g., the application data 570, the equipment data 575, other tunnel data, or a combination thereof. For example, the component placement function 810 may determine a placement of an imaging module that includes multiple imaging devices or other components. Alternatively, or in addition, in some examples, the set of positions or placements for components of the prospective tunnel can be implied by the selection of the appropriate imaging device and imaging module configuration (as an output of the imaging device module selection function 805). Accordingly, in some examples, the placement of components in space can be determined based at least partly on an output of the imaging device module selection function 805 (e.g., based on a resolution, coverage, or clearance analysis).

The coverage and occlusion analysis function 815 may determine coverage information, occlusion information, or a combination thereof for a prospective tunnel. As referred to herein, “coverage” may refer to a physical region or space that can be imaged or captured by the one or more imaging devices of a prospective tunnel (e.g., an imaging coverage or a total FOV), including at specified heights (e.g., at a conveyor, at a maximum expected box height, etc.). As referred to herein, “occlusion” may refer to a blockage or obstruction with respect to an imaging coverage (e.g., a space occupied by a target object which may contain relevant information but cannot be imaged due to an obstruction). In some configurations, the coverage and occlusion analysis function 815 determines coverage related information, occlusion related information, or a combination thereof based on an output of the imaging device module selection function 805, the component placement function 810, another function performed by the configurator 560, or a combination thereof.

As one example, the coverage and occlusion analysis function 815 may receive a selection of a imaging device module for a prospective tunnel as an output of the imaging device module selection function 805, which can designate a set of imaging devices, and a set of corresponding placements for each imaging device (e.g., as designated by a selection and selected configuration of imaging device module under the component placement function 810). Based on the selected imaging device module and the set of corresponding configurations for components thereof, the coverage and occlusion analysis function 815 may determine a coverage provided by one or more of imaging devices based on a corresponding placement for the one or more imaging devices. Alternatively, or in addition, in some instances, the coverage and occlusion analysis function 815 may determine the coverage information, the occlusion information, or a combination thereof based on, e.g., the application data 570, the equipment data 575, the site data 590, other tunnel data, or a combination thereof.

The reader configuration optimization function 820 may determine an optimized configuration for a set of imaging devices. As one example, the optimized configuration may include one or more acquisition settings, such as, e.g., gain, exposure, etc., for obtaining optimal image brightness, noise, contrast, etc. As another example, the optimized configuration may include an optimal trigger metric for the set of imaging devices. The optimal trigger metric may be time-based, distance-based, or the like. In some instances, the reader configuration optimization function 820 may determine the optimized configuration based on, e.g., the application data 570, the equipment data 575, the site data 590, other tunnel data, or a combination thereof. Alternatively, or in addition, in some cases, the reader configuration optimization function 820 may determine the optimized configuration based on an output from another function performed by the configurator 560.

The barcode assignment requirement function 825 may determine a barcode assignment. A barcode assignment may be defined by the possibility of having two or more target objects (e.g., boxes) in the FOV of an imaging device. A barcode assignment may be a physical condition. In some instances, the barcode assignment requirement function 825 may determine the barcode assignment based on, e.g., the application data 570, the equipment data 575, the site data 590, other tunnel data, or a combination thereof. Alternatively, or in addition, in some cases, the barcode assignment requirement function 825 may determine the barcode assignment requirement based on an output from another function performed by the configurator 560. In some examples, the barcode assignment requirement function 825 can assign particular barcodes in images to particular objects based on mapping of 3D locations within 2D space or using other techniques, including according to co-pending U.S. patent application Ser. No. 17/850,802, which is incorporated herein by reference.

The performance margin and gap analysis function 830 may perform a performance margin and gap analysis, including as may guide an operator in determining an optimal configuration for a prospective tunnel. In some cases, the performance margin and gap analysis may provide a metric for expressing what may not be covered in a certain application for the prospective tunnel. For example, the performance margin and gap may indicate whether there is a performance margin available for the tunnel configuration for the prospective tunnel, whether the tunnel configuration for the prospective tunnel provides better performance than desired (e.g., over-coverage of an imaging area), whether the tunnel configuration for the prospective tunnel has a performance gap (e.g., the tunnel configuration for the prospective tunnel does not satisfy the application specifications), or the like. As one example, a performance gap can be identified for a small part of a target object when a tunnel configuration results in the part of the target object being physically occluded. In some configurations, the performance margin and gap analysis function 830 may perform the performance margin and gap analysis based on an output from another function performed by the configurator 560. Alternatively, or in addition, in some configurations, the performance margin and gap analysis function 830 may perform the performance margin and gap analysis based on, e.g., the application data 570, the equipment data 575, the site data 590, other tunnel data, or a combination thereof.

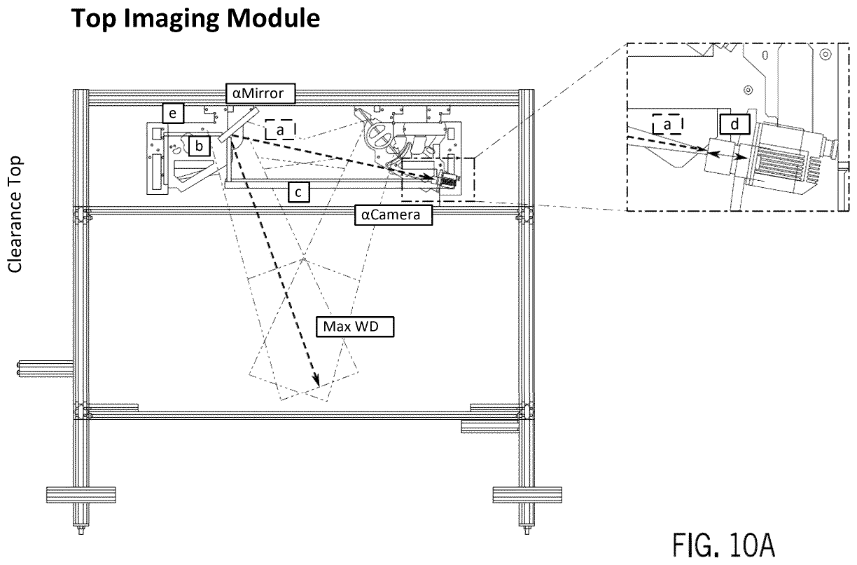

In some implementations, the functionality disclosed herein (e.g., as detailed relative to FIGS. 4-8) can be executed as part of a computer-implemented method. In this regard, for example, FIG. 9 is a flowchart illustrating a method 900 for determining tunnel configurations for a machine vision tunnel according to some configurations. The method 900 is described herein as being performed by the server 410 and, in particular, by the configurator 560 as executed by the electronic processor 500. However, as noted above, the functionality described with respect to the method 900 may be performed by other devices, such as the user device 415, another device or system, or distributed among a plurality of devices, such as a plurality of servers included in a cloud service.

As illustrated in FIG. 9, the method 900 includes receiving, with the electronic processor 500, the application data 570, the equipment data 575, or the site data 590 associated with a particular tunnel (at block 905). As noted above, the application data 570, the equipment data 575, or the site data 590 may be locally stored in the memory 505. Accordingly, the electronic processor 500 may receive the application data 570, the equipment data 575, or the site data 590 by accessing the memory 505. Alternatively, or in addition, in some configurations, the application data 570, the equipment data 575, or the site data 590 may be stored in a remote location, such as, e.g., in a memory of the user device 415, a remote database or device, or the like. In such configurations, the electronic processor 500 receives the application data 570, the equipment data 575, or the site data 590 from a remote location. As one example, an operator may interact with the user device 415 to provide part or all of the application data 570, the equipment data 575, or the site data 590 via the HMI 580. Following this example, the electronic processor 500 may then receive part or all of the application data 570, the equipment data 575, or the site data 590 from the user device 415 (via, e.g., the communication network 430). In some instances, the user device 415 may store the application data 570, the equipment data 575, or the site data 590 provided via the HMI 580 and transmit the application data 570, the equipment data 575, or the site data 590 to the electronic processor 500 at a later point in time. Alternatively, or in addition, the user device 415 may transmit the data to the electronic processor 500 in real-time (or near real-time) as an operator provides the application data 570, the equipment data 575, or the site data 590 at the user device 415. Accordingly, in some configurations, the electronic processor 500 receives the relevant data in real-time (or near real-time).

In some cases, receiving relevant data at block 905 can include receiving data from different sources. As one example, the equipment data 573 may be stored in a database associated with an entity that can equip or assemble a tunnel, such as a product management database, a product inventory database, or the like. In contrast, application or site data 570, 590 may generally be provided by a customer or other tunnel operator. According to this example, the electronic processor 500 may thus receive the equipment data 575 from a different system than the application and site data 570, 590.

As illustrated in FIG. 9, the electronic processor 500 may determine a first tunnel configuration (at block 910). As one example, a tunnel configuration may identify each component of the tunnel, an arrangement of each component of the tunnel, and the like. Accordingly, in some instances, the tunnel configuration can provide a blueprint of a tunnel to be commissioned (e.g., in various human- or machine-readable forms). As described in greater detail herein, in some configurations, a tunnel configuration may be one of a defined set of configurations (or modules) available, or that satisfied a set of constraints or requests of the input data. Accordingly, in some configurations, the electronic processor 500 may determine a tunnel configuration as a predetermined or predefined configuration from a plurality of predetermined or predefined configurations.

In some instances, the electronic processor 500 determines a tunnel configuration based on the application data 570, the equipment data 575, the site data 590, or a combination thereof. As noted above, the application data 570 may include data associated with a specific application of a tunnel, such as, e.g., data associated with a specific customer's intended application of a tunnel. The site data 590 may include data associated with a specific location for a tunnel, such as, e.g., a customer site for the intended tunnel application. Accordingly, in some instances, the electronic processor 500 determines a tunnel configuration that satisfies or meets one or more parameters or specifications of an intended application, a site of a tunnel, or a combination thereof (e.g., a tunnel configuration that meets one or more application- and site-specific customer metrics). As one example, the application and site data 570, 590 may include the following parameters: a conveyor width of 550 mm, a concrete mounting surface, a top clearance of 1800 mm, and a one-dimensional symbology type. Based on these parameters, the electronic processor 500 may determine a tunnel configuration that specifies a tunnel that is compatible with the designated conveyor and site and can be implemented for machine vision functionality with one-dimensional symbologies.

As noted above, the electronic processor 500 may further determine the tunnel configuration based on the equipment data 575 (at block 910). For instance, as noted above, the equipment data 575 may include data associated with one or more components (e.g., imaging modules) that may be implemented with a tunnel, such as, e.g., one or more imaging devices, dimensioners, conveyors, support structures, a imaging device module (including components thereof, such as, e.g., mirrors, lighting, triggers, etc.), auxiliary devices (e.g., photo eye encoder or other additional sensors), communication devices, power distribution components (e.g., I/O hardware), an edge intelligence device, or the like. In some instances, the equipment data 575 can include a predefined module configuration or set of multiple predefined module configurations, as can provide multiple options for a particular implementation of a particular imaging (or other) module. For example, the equipment data 575 can specify different types or configurations of imaging devices that may be available, or different types or configurations or imaging modules that include one or multiple imaging devices and associated accessories (e.g., mirrors, lighting assemblies, etc.).

Generally, the electronic processor 500 may thus determine a tunnel configuration that satisfies one or more parameters specified by the application and site data 570, 590 by determining particular types and configurations of components based on the equipment data 575. For example, based on collective analysis of the input data (e.g., the application data 570, the equipment data 575, or the site data 590) including application of known geometric and optics principles, particular components and configurations thereof can be identified for a particular tunnel configuration. Following the previous example, with respect to the parameter of a conveyor width of 550 mm, the electronic processor 500 may analyze the equipment data 575 to determine a set of components that satisfy parameters associated with a conveyor width of 550 mm and other relevant parameters (e.g., a maximum object size, a maximum code size, etc.), including by determining a set of imaging devices or modules and corresponding configurations that can provide FOVs to appropriately cover the conveyor width for imaging of sufficient resolution, etc.

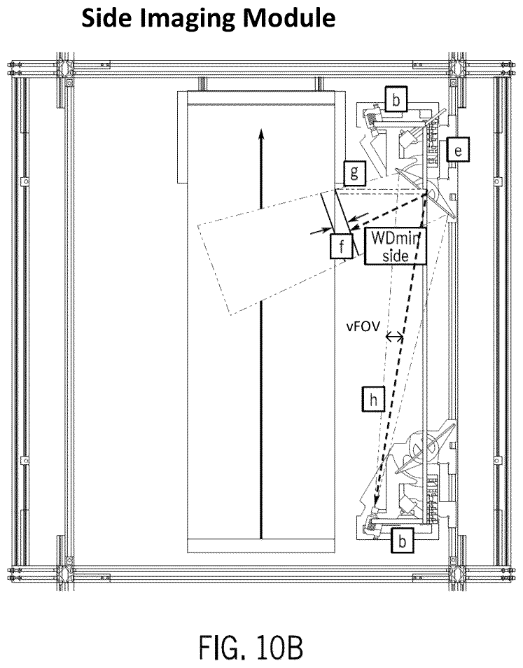

In some cases, analysis of the equipment data 575 to specify a tunnel configuration can include determining an availability status for each component (e.g., available for procurement, not available for procurement, in transit to or from a particular site, etc.), or combinations thereof. The electronic processor 500 may then determine the tunnel configuration based on the set of components, the availability status of each component, or a combination thereof. Following this example, the electronic processor 500 may determine a tunnel configuration that includes a component (or a module configuration) that enables implementation of a tunnel having a conveyor width of 550 mm, where the component (or the module configuration) has an availability status of available or in transit. In some cases, based on analysis of the equipment data 575 and other relevant data 570, 590, the electronic processor 500 can designate tunnel parameters for a tunnel configuration that specify spacing or mounting/imaging angles of particular modules or module components. For example, the electronic processor 500 can determine particular spacings a-e or angles α, as illustrated in FIGS. 10A and 10B.

Alternatively, or in addition, the electronic processor 50 may determine a tunnel configuration based on a set of coverage metrics and coverage thresholds. A coverage metric can generally describe the coverage provided by one or more imaging devices or one or more imaging module configurations. In some cases, a coverage metric can refer to, be partly derived from, or otherwise relate to a particular application or site, as well as coverage information that may be inherent to a particular imaging device or imaging module configuration (e.g., FOV size or angle, working depth, etc.). For examples, the coverage metric may be related to a coverage needed by a specific conveyor belt or other transport system. Alternatively, or in addition, the coverage metric may be related to one or more specified operational (e.g., run-time) parameters for a particular application, such as the coverage needed to view an object that is moving on a conveyor belt width that is the tallest object to be transported by the conveyor belt, or alternatively the coverage needed to view an object at an edge of the conveyor belt, etc. Accordingly, in some instances, the coverage metric relates to a volume in which an object on the conveyor belt may be present.

As one example, a coverage metric may indicate a combined total coverage provided by each imaging device included in a tunnel configuration, a combined coverage provided by a subset of imaging devices included in a tunnel configuration (e.g., a coverage provided by each imaging module configuration included in a tunnel configuration), a coverage provided by a single imaging device included in a tunnel configuration, or the like. As yet another example, a coverage metric may include a maximum coverage provided by a tunnel configuration, a coverage used by a tunnel configuration, an amount of coverage missed by a tunnel configuration (e.g., tunnel conveyor area not sufficiently covered by one or more FOVs), an amount of coverage provided by a tunnel configuration when at least one imaging device (or imaging module configuration) is removed from the tunnel configuration, or the like. Coverage metrics can be expressed in some examples as percentages indicating a relative level of coverage for one or more particular imaging devices or one or more particular imaging modules. For example, coverage metrics can be expressed as a percentage of a distance (e.g., a conveyor width) or area (e.g., a conveyor area within a tunnel scene) that are covered by a normal or an extended field(s) of view of one or more imaging devices or one or more imaging modules. In some examples, in contrast, coverage metrics can be express as absolute measurements of coverage dimensions (e.g., width, area, width at different heights, etc.).

Accordingly, in some configurations, the electronic processor 500 may determine a set of coverage metrics associated with a tunnel configuration. The electronic processor 500 may determine the set of coverage metrics based on the application data 570, the equipment data 575, the site data 590, or a combination thereof. In some cases, the electronic processor 500 may determine the set of coverage metrics based on one or more of the basic geometric principles illustrated in FIGS. 10A-10B, including relative to required and available FOV size at a minimum working distance (e.g., maximum box height), an amount of overlap of FOVs at different heights (e.g., at maximum box height and at conveyor level), etc.

After determining the set of coverage metrics, the electronic processor 500 may evaluate the coverage metrics, including by accessing (or receiving) one or more coverage thresholds. A coverage threshold may define or establish a range, a limit, or the like with respect to coverage of a tunnel (or component or module thereof). In some instances, a coverage threshold indicates an amount of over-coverage or under-coverage of one or more fields of view of one or more imaging devices. Accordingly, in some instances, a coverage metric may include an efficiency metric corresponding to the coverage threshold. As one example, a coverage threshold may be a percentage of coverage with respect to a tunnel application. As another example, a coverage threshold may be an upper limit or a lower limit with respect to coverage provided by a tunnel (or component or module thereof). In some instances, the coverage threshold is a predetermined threshold. As one example, in some instances, the application data 570 may include a coverage threshold as a metric for determining a tunnel configuration. However, in other instances, a coverage threshold is a dynamic threshold that is adjustable by an operator. A coverage threshold may be stored locally in the memory 505 of the server 405. Alternatively, or in addition, a coverage threshold may be stored remotely, e.g., in a memory device of another device, such as the user device 415.

The electronic processor 500 may compare a coverage metric to a coverage threshold to determine whether the coverage metric satisfies the coverage threshold. As one example, when a coverage metric is within a coverage range defined by the coverage threshold, the electronic processor 500 may determine that the coverage metric satisfies the coverage threshold. As another example, when a coverage metric is above a limit defined by the coverage threshold, the electronic processor 500 may determine that the coverage metric satisfies the coverage threshold. As yet another example, when the coverage metric is below a limit defined by the coverage threshold, the electronic processor 500 may determine that the coverage metric does not satisfy the coverage threshold.

Accordingly, in some instances, the comparison of a coverage metric of a tunnel configuration to a coverage threshold may serve as a pre-condition for determining the tunnel configuration. For example, only tunnel configurations (or components) associated with one or more coverage metrics that satisfy a coverage threshold (or thresholds) may be determined as a viable tunnel configuration.

The electronic processor 500 may generate and transmit, a configuration summary for the first tunnel configuration (at block 915). As also discussed herein, a configuration summary can include a useful subset of information associated with a corresponding tunnel configuration and can thus generally assist operators in evaluating, adjusting, finalizing, and implementing particular tunnel configurations. In some cases, a configuration summary may include information generated by the configurator 560, as well as certain relevant inputs to analysis by the configurator 560. For example, to assist in operator engagement or other functionality, a configuration summary can specify select application data 570, select equipment data 575, or select site data 590, including a set of coverage metrics, one or more coverage thresholds, other data associated with a tunnel configuration, or a combination thereof.

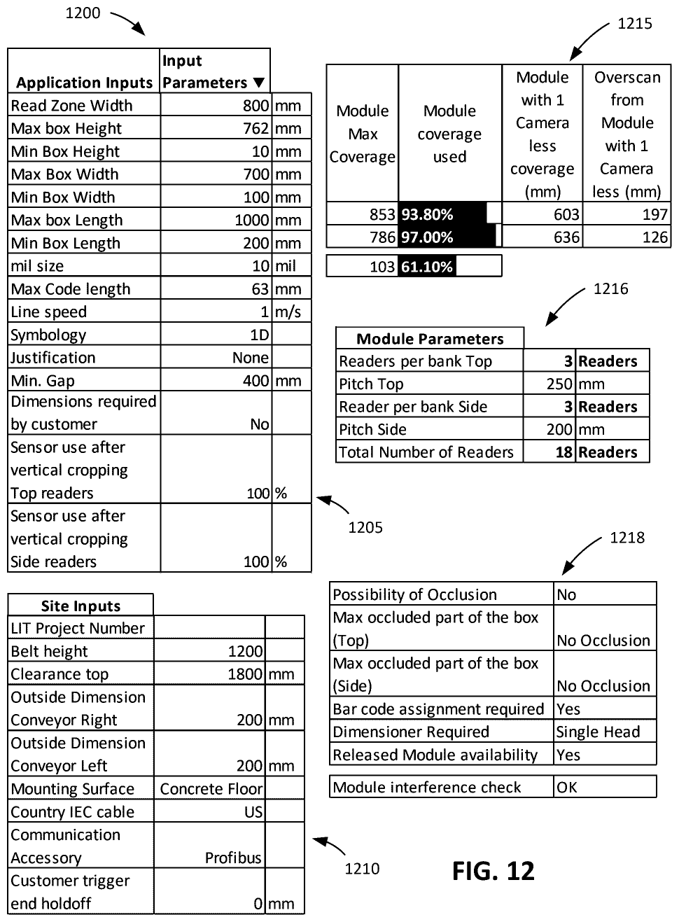

FIG. 12 illustrates an example configuration summary 1200 according to some configurations. As illustrated in FIG. 12, the configuration summary 1200 includes a set of application inputs 1205 and a set of site inputs 1210 (e.g., as a subset of the application and site data 570, 590). The configuration summary 1200 also includes a set of coverage metrics 1215 and an equipment summary 1216. As also noted above, the coverage metrics 1215 can generally indicate the coverage provided by one or more imaging devices (e.g., as configured within an adjustable imaging module). In the illustrated example, the set of coverage metrics 1215 includes a module maximum coverage, a module coverage used (e.g., expressed as a percentage efficiency metric of the available FOV coverage that is used for the present configuration), a module with one imaging device less coverage, and an overscan from module with one imaging device less (e.g., a delta in coverage between the current tunnel configuration and a tunnel configuration with at least one less imaging device). In other examples, other parameters can be included.

Generally, an equipment summary can specify details regarding particular types or configurations of equipment for a tunnel configuration, as determined by the configurator 560. In some cases, an equipment summary can include parameters to specify aspects of an imaging module for the configured tunnel or otherwise indicate a quantity, type, or configuration of equipment included in the tunnel. For example, the equipment summary 1216 as illustrated in FIG. 12 includes set of module parameters that characterize the number of imaging devices (“readers” in this example) on top and side modules for a tunnel and the pitch of those devices on the modules. For example, the equipment summary 1216 for the illustrated configuration summary 1200 can designate a number of imaging devices (“readers” in this example) per top imaging module, a number of readers per side imaging module, pitch values for those modules, and a total number of readers.

In some examples, an equipment (or configuration) summary can provide other information. For example, as shown in FIG. 12, an operational summary 1218 included in the configuration summary 1200 can include: an occlusion indicator that indicates whether an occlusion is expected for imaging objects (e.g., due to a predetermined maximum object size and minimum object spacing); an indicator of a maximum occluded part of an object (e.g., coordinates or other measurements for a top or side portion of an object that may be occluded); an indicator of whether bar code assignment may be required; an indicator of a type of dimensioner that may be required; an indicator of availability for a released module (e.g., as based on inventory data and the module parameters of the equipment summary 1216), or an indicator of whether a module interference check has been satisfied (e.g., with “OK” indicating that no interference is expected).

In some instances, the electronic processor 500 generates a configuration summary based on a comparison of a coverage metric to a coverage threshold. Accordingly, in some instances, the comparison of a coverage metric of a tunnel configuration to a coverage threshold may serve as a trigger or pre-condition for generating a configuration summary of that tunnel configuration. As one example, the electronic processor 500 generates the configuration summary in response to at least one coverage metric satisfying a coverage threshold. For example, in order for a configuration summary of a tunnel configuration to be generated, one or more coverage metrics of that tunnel configuration must satisfy a coverage threshold (or coverage thresholds). Accordingly, in some configurations, the electronic processor 500 compares a coverage metric for a possible tunnel configuration to a coverage threshold as part of generating the configuration summary (e.g., prior to generating the configuration summary).

The electronic processor 500 may transmit part or all of the configuration summary to an operator, such that an operator may interact with the configuration summary. In some instances, the electronic processor 500 may transmit the configuration summary to the user device 415 (via the communication network 430) for display to the operator via the display device 585. In response to receiving the configuration summary, the user device 415 may provide (e.g., visually display) the configuration summary to an operator.

As one example, the user device 415 may provide the configuration summary to the operator by displaying the configuration summary via the display device 585. An operator may interact with the configuration summary using the user device 415. An operator may interact with the configuration summary by viewing the configuration summary. Alternatively, or in addition, an operator may interact with the configuration summary by providing input to the configuration summary (e.g., via the HMI 580). In some examples, the operator input may include a modification to an input or other parameter associated with the configuration summary (e.g., changing or removing a particular parameter). Alternatively, or in addition, in some examples, the operator input may provide a new input or parameter for inclusion in the configuration summary.

Correspondingly, in some implementations, multiple tunnel configurations can be determined iteratively, including as based on automatic analysis of a completed configuration, operator input (e.g., as discussed immediately above), or other factors. For example, after a tunnel configuration has been determined, the user device 415 may receive one or more modified tunnel parameters via operator interaction with the HMI 580, and the user device 415 may provide the one or more modified tunnel parameters to the electronic processor 500. In response to receiving the modified tunnel parameters, the electronic processor 500 may determine a new tunnel configuration (e.g., a subsequent tunnel configuration) based on the modified tunnel parameter(s). The electronic processor 500 may also then generate an updated configuration summary (e.g., a subsequent configuration summary) for the new tunnel configuration (e.g., as detailed relative to block 915, above), which can be presented to an operator or used to generate particular specification packages as variously described elsewhere herein.

Accordingly, in some instances, the electronic processor 500 detects (or receives) an operator interaction with the configuration summary. In response to detecting (or receiving) the operator interaction, the electronic processor 500 may determine a second tunnel configuration based on at least one modified tunnel parameter included in the operator interaction such that the second tunnel configuration satisfies the at least one modified tunnel parameter. The electronic processor 500 may then generate, and transmit to the user device 415, a second or subsequent configuration summary for the second or subsequent tunnel configuration. The electronic processor 500 may repeat these steps, as appropriate, for each operator interaction with the configuration summary that modifies a tunnel parameter. Correspondingly, for each iteration in some cases, an updated or new tunnel configuration can be generated that reflects the modified tunnel parameter(s). Further, as appropriate, an updated or new configuration summary can be generated accordingly and transmitted for relevant updated or new tunnel configurations.

Thus, in some instances, the configuration summary may be a dynamic configuration summary where the information or content (or a portion thereof) provided via the configuration summary is updated based on operator interaction with the configuration summary. In some configurations, the configuration summary can be updated in real-time (or near real-time) in response to an operator interaction, such that the configuration summary dynamically reflects a current tunnel configuration (e.g., a most-current tunnel configuration version or iteration) as an operator provides modified input data for further operations by the configurator 560.

Returning again also to FIG. 9, in addition, or in alternative to, the configuration summary 1200, the electronic processor 500 may generate and transmit an electronic specification package based on the tunnel configuration (at block 920). In some instances, the electronic specification package may include a bill of materials report for the current tunnel configuration. As one example, a bill of materials report for a tunnel configuration may include a list of one or more components or component configurations (e.g., imaging module configurations) included in the tunnel configuration. For example, a bill of materials report may identify each imaging module and relevant associated configuration for a tunnel, as well as relevant support structures, electronic communication components (e.g., appropriately specified connectors, ports, firmware, etc.), or other details, including as can allow a manufacturing or assembly operation to prepare a full set of components for a particular tunnel configuration. For example, a bill of materials report can include product numbers for components of a particular tunnel configuration, related price information or various cost analyses (e.g., cost comparisons or cost-benefit analyses), or related functional components. In some cases, a bill of materials can include functional components configured as hyperlinks or other GUI input components that can allow operators to order components for a tunnel configuration, to generate or transmit additional reports regarding a tunnel configuration (e.g., purchase orders, schematics, etc.), or otherwise utilize the information in the bill of materials report to assist in evaluating, selecting, ordering, installing, or commissioning a particular tunnel configuration.

Alternatively, or in addition, in some examples, a configurator 560 can generate multiple bill of materials reports or other specification packages. In some such examples, each bill of materials report may be different such that each bill of materials provides a different configuration option for the prospective tunnel (e.g., different performance margins, cost margins, etc.). As one example, each bill of materials report may be associated with a different characteristic, such as, e.g., a total cost associated with the prospective tunnel or compliance with particular application or site parameters. As another example, each bill of materials report may be associated with a different material list.

Alternatively, or in addition, an electronic specification package may include a tunnel commissioning package for the tunnel configuration, as can be used to assist operators in commissioning a tunnel on site relative to a particular tunnel configuration. As one example, the tunnel commissioning package may include a device commissioning file. As another example, the tunnel commissioning package may be an executable software file for commissioning one or more devices associated with a corresponding tunnel configuration. For example, commissioning parameters included in a commissioning report may include component identification, spatial (e.g., 3D) coordinates or orientation data associated with certain components (e.g., a bank of imaging devices), a list of imaging devices or banks of imaging devices provided by an imaging module (e.g., an imaging device identifier for each imaging device included in each bank of imaging devices), communications data (e.g., an standard internet protocol (“IP”) address or port information), various application specific settings (e.g., including one or more scripts), or the like.

Alternatively, or in addition, an electronic specification package may include a graphical representation of the tunnel configuration. The graphical representation may be, e.g., a computer aided design (“CAD”) solid model, a CAD drawing generation, another type of graphical representation, or the like that can provide a visual representation of the tunnel once the tunnel is installed. In some cases, such a graphical representation can be useful for manufacture, assembly, installation, or commissioning of a particular tunnel configuration.

In some configurations, the electronic processor 500 generates and transmits the electronic specification package in response to operator confirmation of a tunnel configuration, including as indicated via operator interaction with a configuration summary. For example, in some instances, the electronic processor 500 receives an operator confirmation of a tunnel configuration after review of a configuration summary, as provided by an operator to the user device 415. The user device 415 may transmit the operator confirmation to the electronic processor 500 over the communication network 430, so that the operator confirmation may indicate to the configurator 560 an approval of the tunnel configuration. In response to receiving the operator confirmation approving the tunnel configuration, the electronic processor 500 may then generate and transmit a relevant electronic specification package.

In some instances, the electronic processor 500 generates multiple electronic specification packages based on a tunnel configuration. As one example, the electronic processor 500 may simultaneously generate a bill of materials report of the tunnel configuration, a tunnel commissioning package of the tunnel configuration, a graphical representation of the tunnel configuration, or a combination thereof.

The electronic processor 500 may transmit one or more of the electronic specification packages to the same device (e.g., the user device 415) or multiple different devices (e.g., the user device 415 and a remote database). As one example, the electronic processor 500 may transmit the bill of materials report to the user device 415 for display to an operator and the tunnel commissioning package to a remote database for storage, such that the tunnel commissioning package may be accessed during a commissioning process of the tunnel. As another example, the electronic processor 500 may transmit the bill of materials report, the tunnel commissioning package, and the graphical representation to a remote database for storage. As yet another example, the electronic processor 500 may transmit the bill of materials to the user device 415 for display to an operator and to a remote database for storage. As yet another example, the electronic processor 500 may transmit the bill of materials to a supplier for fulfillment, and a tunnel commissioning package (or other associated specification package) to a customer for use in commissioning the relevant tunnel.

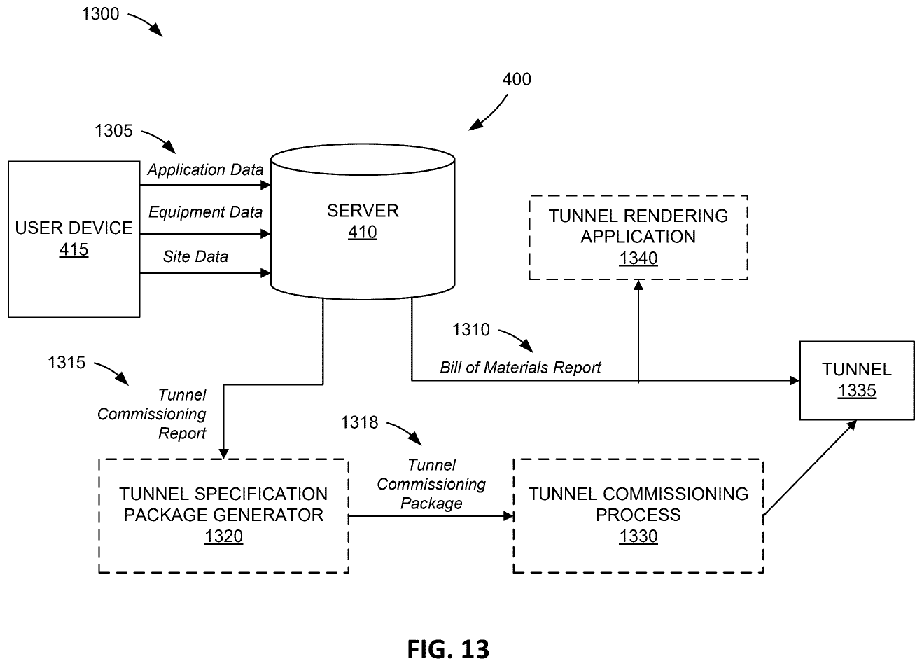

Thus, in some cases, a configurator module for tunnels can be implemented as part of a larger system to improve processes for design and implementation of machine vision tunnels. For example, FIG. 13 is a diagram 1300 illustrating an example data or communication flow between components of the system 400 and other systems according to some configurations. As illustrated in FIGS. 5 and 13 collectively, the server 410 (e.g., via the electronic processor 500 executing the configurator 560) may receive the application data 570, the equipment data 575, the site data 590, or a combination thereof from the user device 415 (represented in FIG. 13 by reference numeral 1305). As noted above, in some instances, the application data 570, the equipment data 575, the site data 590, or a combination thereof may be received from another component other than the user device 415, such as, e.g., a remote database or computing device. The server 410, via the electronic processor 500 executing the configurator 560, may then process the received input data as described herein (e.g., as detailed above) to determine one or more outputs.

As illustrated in FIG. 13 and also described herein, once a tunnel configuration has been determined, the server 410 may output a corresponding bill of materials report (represented in FIG. 13 by reference numeral 1310), a different tunnel specification package or a combination thereof. In some instances, a tunnel specification package can be, in particular, a tunnel commissioning report (represented in FIG. 13 by reference numeral 1315) that can be further processed to generate a tunnel commissioning package (represented in FIG. 13 by reference numeral 1318) for further operations (e.g., as also discussed herein). For example, the server 410 may output, to a tunnel specification package generator 1320, a tunnel commissioning report 1315 that includes particular tunnel parameters relevant to commissioning. The tunnel specification package generator 1320 may then analyze the tunnel commissioning report 1315 to generate a tunnel specification package 1318 for commissioning that is specific to the relevant tunnel configuration (i.e., a particular tunnel commissioning package).

In some instances, the tunnel commissioning package 1318 may include an executable software file for commissioning a tunnel. For example, as also discussed herein, a tunnel commissioning package 1318 can include application specific settings for the tunnel or components thereof, orientation data associated with a bank of imaging devices, a list of imaging devices included in a bank of imaging devices, including, for each imaging device included in the bank of imaging devices, e.g., an imaging device identifier, a standard internet protocol (“IP”) address, an application specific setting (including one or more scripts), or coordinates (e.g., 3D coordinates) describing a position of the imaging device, or the like. The tunnel commissioning process 1330 may then ultimately be performed on the tunnel (represented in FIG. 13 as tunnel 1335) using the data included in the tunnel specification package 1318.

As also illustrated in FIG. 13, the server 410 (the electronic processor 500 executing the configurator 560) may output a bill of materials report 1310 (e.g., as described in greater detail herein). The bill of materials report 1310 may be used by a manufacture or tunnel operator to physically equip the tunnel 1335 (e.g., identify and locate each component or module configuration of the tunnel). Alternatively, or in addition, the bill of materials report 1310 may be provided to a tunnel rendering application 1340, which may provide a graphical representation of the tunnel 1335.

Accordingly, the configurations described herein provide method and systems for determining configurations of tunnels (e.g., machine vision tunnels). In some instances, the method and systems for determining configurations of tunnels, as described herein, may be implemented as part of a pre-commissioning process which occurs prior to installation and commissioning of a prospective tunnel on site. A pre-commissioning process may include a design phase or state in which a prospective tunnel is planned or designed, including, e.g., prior to (or at the time of) submission of an order or purchase order for the prospective tunnel. In some instances, the pre-commissioning process occurs prior to an installation process or a commissioning process (e.g., on-site tuning) for the prospective tunnel. An installation process for the prospective tunnel may include, e.g., installing the physical or structural assembly of the prospective tunnel on site (e.g., at an end user's facility or warehouse). A commissioning process for the prospective tunnel may include, e.g., the commissioning of one or more configurable components of the installed tunnel (e.g., setting up network or other communication connections, tuning imaging or other parameters, etc.). For instance, a commissioning process may include commissioning one or more imaging devices using, e.g., an executable file.

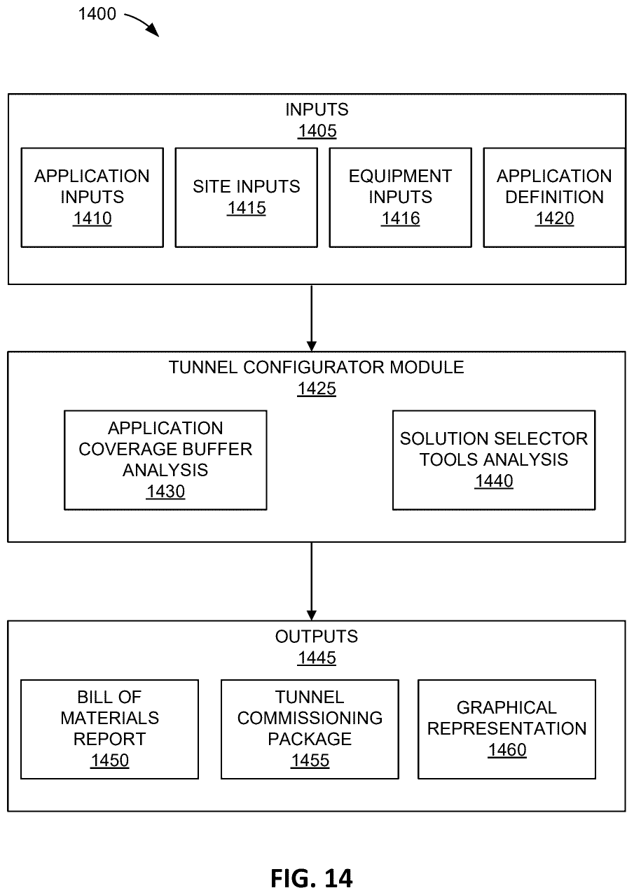

Correspondingly, FIG. 14 illustrates an example high level diagram 1400 of the methods and systems described herein according to some configurations. As illustrated in FIG. 14, the configurations described herein may be implemented by receiving a set of inputs 1405. The set of inputs 1405 may include, e.g., application inputs 1410 (e.g., as described herein with respect to the application data 570), site inputs 1415 (e.g., as described herein with respect to the site data 590), and equipment inputs 1416 (e.g., as described herein with respect to the equipment data 575). In some cases, the inputs 1405 can additionally or alternatively generally include an application definition 1420, as may include various additional parameters that can be defined by a tunnel operator or otherwise.

In some instances, the set of inputs 1405 may include additional, different, fewer, or different combinations of inputs than are illustrated in FIG. 14. Generally, the set of inputs 1405 may be used by a tunnel configurator module 1425 (e.g., the configurator 560). The tunnel configurator module 1425 may include, e.g., an application coverage buffer analysis 1430 (as similarly described herein with respect to coverage metrics and coverage thresholds) and a solution selector tools analysis 1440 (e.g., a comparison of various tunnel configuration options). The tunnel configurator module 1425 may thus produce a set of outputs 1445 based on the inputs 1405 as processed according to relevant analyses performed by the tunnel configurator module 1425. The set of outputs 1445 may include, e.g., a bill of materials report 1450, a tunnel commissioning package 1455, and a graphical representation 1460 (as described herein with respect to the electronic specification package).

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the technology, or of systems executing those methods, may be represented schematically in the FIGs. or otherwise discussed herein. Unless otherwise specified or limited, representation in the FIGs. of particular operations in particular spatial order may not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of.”

Although the present technology has been described by referring to preferred examples, workers skilled in the art will recognize that changes may be made in form and detail without departing from the scope of the disclosure.

1. A system for generating machine vision tunnel configurations, the system comprising:
one or more electronic processors configured to:
receive application data for a prospective tunnel;
determine a first tunnel configuration for the prospective tunnel based on the application data;
generate and transmit, for display via a user device, a first configuration summary for the first tunnel configuration; and
generate and transmit an electronic specification package based on the first tunnel configuration, wherein the electronic specification package includes a listing of components for the prospective tunnel and a set of commissioning parameters, wherein each component included in the listing of components is associated with at least one commissioning parameter included in the set of commissioning parameters.

2. The system of claim 1, wherein the one or more electronic processors are configured to generate the electronic specification package during a pre-commissioning process prior to installation and commissioning of the prospective tunnel.

3. The system of claim 1, wherein the one or more electronic processors are configured to receive equipment data associated with the prospective tunnel, wherein the first tunnel configuration is determined based on the equipment data and the application data.

4. The system of claim 1, wherein the application data are related to an intended application of the prospective tunnel.

5. The system of claim 1, wherein the one or more electronic processors are configured to:
determine, based on the application data, a coverage metric for the first tunnel configuration, wherein the first configuration summary includes the coverage metric.

6. The system of claim 5, wherein the coverage metric is a prospective imaging coverage provided by a total field of view (“FOV”) of one or more imaging devices included in the first tunnel configuration.

7. The system of claim 5, wherein the coverage metric includes at least one of: a maximum coverage provided by the first tunnel configuration, a coverage used by the first tunnel configuration, an amount of coverage missed by the first tunnel configuration, or an amount of coverage provided when at least one imaging device is removed from the first tunnel configuration.

8. The system of claim 1, wherein the one or more electronic processors are configured to:
detect a user interaction with the first configuration summary, wherein the user interaction modifies a tunnel parameter included in the first configuration summary or the application data; and
in response to detecting the user interaction,
determine, based on the modified tunnel parameter, a second tunnel configuration for the prospective tunnel, wherein the second tunnel configuration reflects the modified tunnel parameter,
generate and transmit to the user device for display, a second configuration summary for the second tunnel configuration, and
generate and transmit a second electronic specification package for the second tunnel configuration.

9. The system of claim 1, wherein the electronic specification package includes:
a bill of materials report for the first tunnel configuration, wherein the bill of materials report includes the listing of components; and
a graphical representation of the first tunnel configuration.

10. The system of claim, wherein the electronic specification package includes a tunnel commissioning package for the first tunnel configuration, wherein the tunnel commissioning package include the set of commissioning parameters for the first tunnel configuration and an executable software file that, upon execution during a commissioning process for the prospective tunnel, commissions an imaging device included in the listing of components.

11. The system of claim 1, wherein the one or more electronic processors are configured to generate and transmit the electronic specification package in response to receiving an input corresponding to a user selection of the first tunnel configuration.

12. The system of claim 3, wherein the one or more electronic processors are configured to:
receive a site data including a constraint for an installation site of the prospective tunnel,
wherein the first tunnel configuration is determined based on the site data, the application data, and the equipment data.

13. A method of generating machine vision tunnel configurations, the method comprising:
receiving, with one or more electronic processors, application data and site data for a prospective tunnel, and equipment data for a plurality of tunnel components corresponding to the prospective tunnel and including an adjustable imaging module;
determining, with the one or more electronic processors, a first tunnel configuration for the prospective tunnel based on the application data, the site data, and the equipment data, wherein the first tunnel configuration includes a module configuration for the adjustable imaging module;
automatically generating, with the one or more electronic processors, a first configuration summary of the first tunnel configuration including selected equipment data to specify the module configuration; and
responsive to user input, automatically generating, with the one or more electronic processors, an electronic specification package including at least one of a bill of materials report for the prospective tunnel, a digital representation of the prospective tunnel, or a tunnel commissioning package including a set of commissioning parameters for the prospective tunnel.

14. The method of claim 13, wherein the selected equipment parameters specifying the module configuration include at least one of: a number of imaging devices included in the adjustable imaging module, a pitch for each imaging device included in the adjustable imaging module, a location of the adjustable imaging module on a support structure, or an angular orientation of the adjustable imaging module.

15. The method of claim 13, further comprising:
determining, based on the application data, coverage metrics associated with the first tunnel configuration; and
determining whether a coverage metric of the coverage metrics satisfies a coverage threshold, wherein the coverage threshold indicates an amount of over-coverage or under-coverage of a FOV of an imaging device corresponding to the adjustable imaging module,
wherein the first configuration summary is generated in response to satisfying the coverage threshold, and
wherein the coverage metrics include an efficiency metric corresponding to the coverage threshold.

16. The method of claim 13, further comprising:
detecting a user interaction with the first configuration summary, wherein the user interaction modifies a tunnel parameter of the first tunnel configuration; and
in response to detecting the user interaction,
determining, based on the modified tunnel parameter, a second tunnel configuration for the prospective tunnel, wherein the second tunnel configuration incorporates the modified tunnel parameter,
generating a second configuration summary for the second tunnel configuration, and
generating a second electronic specification package for the second tunnel configuration.

17. The method of claim 13, further comprising:
with the electronic processor, in response to receiving user selection of the first tunnel configuration, generating and transmitting an electronic specification package based on the first tunnel configuration;
wherein generating and transmitting the electronic specification package includes generating and transmitting a tunnel commissioning package for the first tunnel configuration, wherein the tunnel commissioning package includes a set of commissioning parameters associated with commissioning the prospective tunnel according to the first tunnel configuration.

18. A method for determining configurations for prospective machine vision tunnels, the method comprising:
receiving, with one or more electronic processors, application data for a prospective machine vision tunnel;
determining, based on the application data, with the one or more electronic processors, a first tunnel configuration for the prospective machine vision tunnel;
generating, with the one or more electronic processors, a first configuration summary for the first tunnel configuration;
enabling, with the one or more electronic processors, transmission of the first configuration summary to a user device for display;
generating, with the one or more electronic processors, an electronic specification package based on the first tunnel configuration, the electronic specification package including an executable software file for commissioning one or more components of the prospective machine vision tunnel based on the first tunnel configuration; and
enabling, with the one or more electronic processors, transmission of the electronic specification package for commissioning of the prospective machine vision tunnel upon execution of the executable software file.

19. The method of claim 18, wherein generating the electronic specification package includes generating at least one of: a graphical representation of the prospective machine vision tunnel based on the first tunnel configuration, a tunnel commissioning package, including the executable software file, or a bill of materials report for the prospective machine vision system based on the first tunnel configuration.

20. The method of claim 18, wherein generating the first configuration summary includes generating a dynamic configuration summary reflecting a most-current tunnel configuration version.
